(19) United States
(12) Patent Application Publication
(10) Pub. No.: US 2025/0276424 A1
(43) Pub. Date: Sep. 4, 2025

(54) ABRASIVE ARTICLES, METHODS OF MANUFACTURE AND USE THEREOF

(71) Applicant: 3M INNOVATIVE PROPERTIES COMPANY, St. Paul, MN (US)

(72) Inventors: Blake R. Rustad, Woodbury, MN (US); Mark A. Lukowski, St. Paul, MN (US); Jonathan J. O'Hare, Woodbury, MN (US); Ernest L. Thurber, Somerset, WI (US); Thomas J. Anderson, Cottage Grove, MN (US); Yuyang Liu, St. Paul, MN (US); Brian G. Koethe, Cottage Grove, MN (US); Eric L. Askeland, Lakeville, MN (US)

(21) Appl. No.: 18/859,119

(22) PCT Filed: Apr. 21, 2023
(86) PCT No.: PCT/IB2023/054116

§ 371 Date: Oct. 22, 2024

Related U.S. Application Data
(60) Provisional application No. 63/363,640, filed on Apr. 26, 2022.

(51) Int. Cl. B24D 11/00; B24D 11/02; C09K 3/14

(52) U.S. Cl. CPC B24D 11/008; B24D 11/02; C09K 3/1409

(57) ABSTRACT

An abrasive article is presented that includes a backing, a make coat applied on the backing, and a plurality of shaped abrasive particles embedded in the make coat. A coat weight of the plurality of shaped abrasive particles is greater than 300 particles per square inch. The abrasive article, when used to abrade a substrate, exhibits a GT1 Total Cut LP of at least 975, a GT1 Total Cut MP of at least 4250, and a GT1 Total Cut HP of at least 5075 grams in accordance with Grinding Test 1.

### BACKGROUND

Abrasive particles and abrasive articles including abrasive particles are useful for abrading, finishing, or grinding a wide variety of materials and surfaces in the manufacturing of goods. As such, there continues to be a need for improving the cost, performance, or life of abrasive particles or abrasive articles.

### SUMMARY

An abrasive article is presented that includes a backing, a make coat applied on the backing and a plurality of shaped abrasive particles embedded in the make coat. A coat weight of the plurality of shaped abrasive particles is greater than 300 particles per square inch. The abrasive article, when used to abrade a substrate, exhibits a GT1 Total Cut LP of at least 975 grams, a GT1 Total Cut MP of at least 4250 grams, and a GT1 Total Cut HP of at least 5075 grams in accordance with Grinding Test 1.

Shaped abrasive particles, in general, can have superior performance over randomly crushed abrasive particles. However, there are general expectations as to how different coat weights of shaped abrasive particles will perform at different applied pressures. Generally, the higher the coat weight, the lower the performance expected at low or medium pressures, as the pressure spreads out over the higher number of particle tips and the tips do not fracture and generate new, sharp tips. In contrast, low coat weight belts are also not expected to perform well under high pressure as the unit pressure on each tip is too high and the particles fracture and break down too quickly.

Surprisingly, a construction has been found that has good performance across a large range of pressures, and across a wider range of coat weights.

### BRIEF DESCRIPTION OF THE DRAWINGS

FIGS. 1A-1B are a schematic perspective view of shaped abrasive particles that may be used in exemplary articles described herein.

FIGS. 2A-2C illustrate different shaped abrasive particles that may be used to form abrasive articles.

FIG. 3 illustrates a method of forming an abrasive article in accordance with embodiments herein.

FIG. 4 illustrates a cutaway view of an exemplary abrasive article in accordance with embodiments herein.

FIGS. 5A-5C illustrate example thickness measurements for abrasive particles herein.

FIGS. 6A-6B illustrate example side length measurements for abrasive particles herein.

FIGS. 7-8 illustrate grinding data described in detail in the Examples.

While the above-identified drawing figures set forth several embodiments of the present disclosure, other embodiments are also contemplated; for example, as noted in the discussion. In all cases, the disclosure is presented by way of representation and not limitation. It should be understood that numerous other modifications and embodiments can be devised by those skilled in the art, which fall within the scope and spirit of the principles of the disclosure. The figures may not be drawn to scale. Like reference numbers may have been used throughout the figures to denote like parts.

### DETAILED DESCRIPTION

The following definitions apply throughout the specification and claims.

The term “aspect ratio” refers to the side length (as defined herein) divided by the thickness (as defined herein). In order to determine the aspect ratio of shaped abrasive particles according to this specification, thickness and side length determinations for the same 20 randomly selected shaped abrasive particles (see below) are used.

The term “length” refers to the maximum extent of an object along its greatest dimension.

The term “width” refers to the maximum extent of something along a dimension orthogonal to the length.

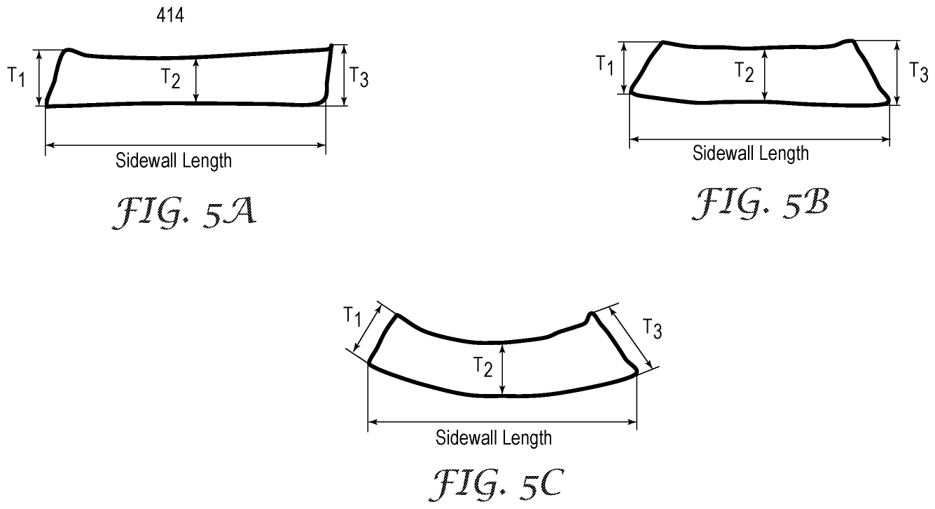

The term “thickness” refers to the maximum extent of something along a dimension orthogonal to both the length and the width. In order to determine the thickness of shaped abrasive particles according to this specification, 20 shaped abrasive particles are randomly selected from a larger batch of like particles, and three thickness measurements (T₁, T₂, and T₃) are taken for each of the 20 particles along a sidewall at (i) each end of the sidewall; and (ii) the center of the sidewall (as shown, for example, in FIGS. 5A-C). The resulting 60 individual thickness measurements are then averaged to determine the thickness of the shaped abrasive particles.

The term “major surface” refers to a surface that is larger than at least half of the surfaces in the object being referenced.

The term “perimeter” refers to a closed boundary of a surface, which may be a planar surface, or a non-planar surface.

The term “precisely shaped” means that the shape is replicated from a mold cavity used during making of the ceramic abrasive particle. The term “precisely shaped” excludes random shapes obtained by a mechanical crushing operation or explosive comminution.

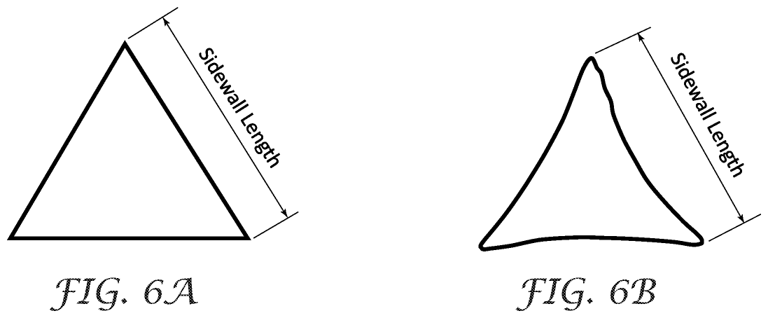

The term “side length” refers to a straight-line distance from tip-to-tip for a shaped abrasive particle along on of its sidewalls (as shown, for example, in FIGS. 5A-6B). In order to determine the side length of shaped abrasive particles according to this specification, 20 shaped abrasive particles are randomly selected from a larger batch of like particles, and side length measurement is taken for each of the 20 particles along a sidewall. The resulting 20 individual side length measurements are then averaged to determine the side length of the shaped abrasive particles.

The features and advantages of the present disclosure will be further understood upon consideration of the detailed description as well as the appended claims.

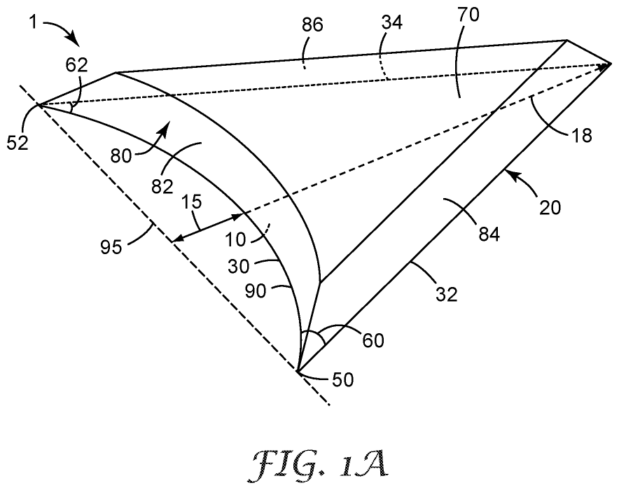

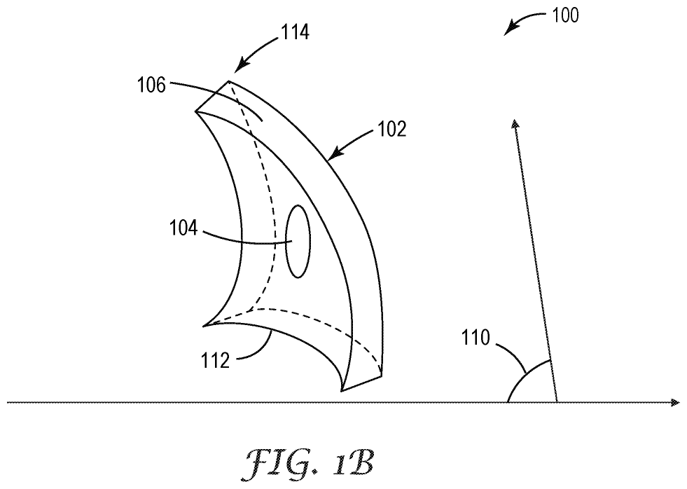

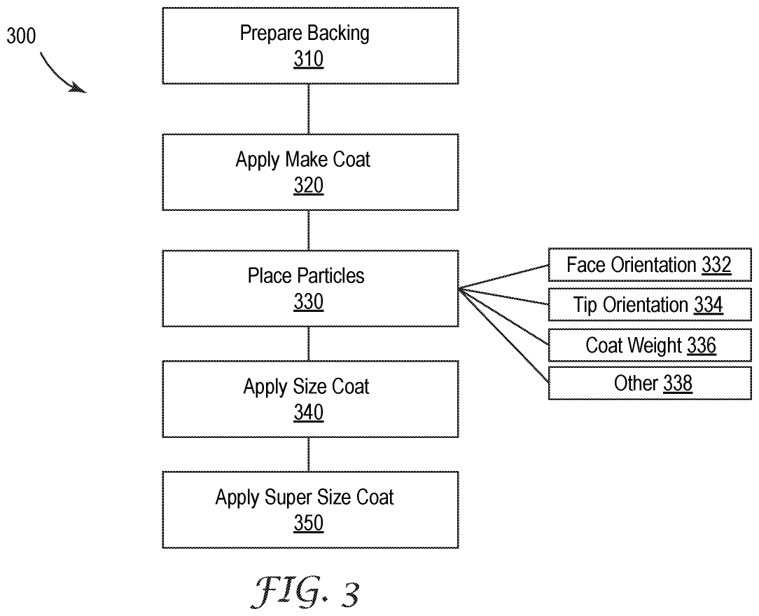

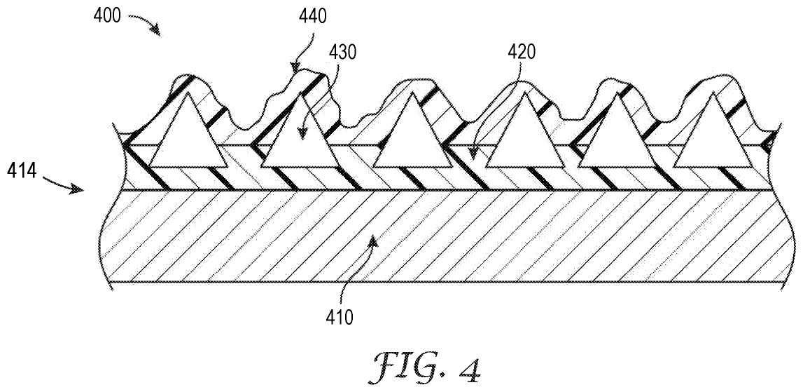

FIGS. 1A-1B are schematic perspective views an exemplary shaped abrasive particles that may be used in abrasive articles according to the present disclosure. Particles of the shape illustrated FIG. 1A are described in greater detail in U.S. Pat. No. 10,301,518 B2, issued on May 28, 2019, which is incorporated herein by reference (for example, see FIGS. 3-5 and the associated description). Particles of the shape illustrated in FIG. 1B are described in greater detail in Published PCT Application WO 2021/245492 (Liu et al.), published Dec. 9, 2021. (see, for example, FIGS. 6A-6B and associated description, incorporated herein by reference) and in Published PCT Application No. WO 2021/245494 (Liu et al.), published on Dec. 9, 2021. (see, for example, FIGS. 4A-4B and associated description, which is incorporated herein by reference). Referring now to FIG. 1A, exemplary shaped ceramic abrasive particle 1 comprises first surface 10 having perimeter 20. Perimeter 20 comprises first, second, and third edges 30, 32, 34. First edge 30 is a concave monotonic curve, while second and third edges 32, 34 are substantially straight edges. However, it is expressly contemplated that, in some embodiments, second and/or third edges, or all three edges, may be concave monotonic curves. Second surface 70 is opposite, and does not contact, first major surface 10. Peripheral surface 80 has a predetermined shape, and is disposed between and connects first and second surfaces 10, 70. Peripheral surface 80 comprises first, second, and third walls 82, 84, 86. First, second, and third edges 30, 32, 34 respectively represent the intersection of first, second, and third walls 82, 84, 86 with perimeter 20. First region 90 of perimeter 20 comprises inwardly extending first edge 30, and terminates at first and second corners 50, 52 defining respective first and second acute interior angles 60, 62.

As shown in FIG. 1A, the first region of the perimeter may comprise a single curved inwardly extending edge, however it is also contemplated that the first region of the perimeter may comprise multiple edges (e.g., 2, 3, 4, 5, 6, 7, 8, 9, 10 edges, or more), any or all of which may comprise inwardly extending curvature.

The term “draft angle” refers to an angle of taper, incorporated into a wall of a mold cavity so that the opening of the mold cavity is wider than its base. The draft angle can be varied to change the relative sizes of the first and second surfaces and the sides of the peripheral surface. In various embodiments of the present disclosure, the draft angle μ can be 90 degrees or in a range of from about 95 degrees to about 130 degrees, from about 95 degrees to about 125 degrees, from about 95 degrees to about 120 degrees, from about 95 degrees to about 115 degrees, from about 95 degrees to about 110 degrees, from about 95 degrees to about 105 degrees, or from about 95 degrees to about 100 degrees. As used herein, the term draft angle also refers to the angle of taper of walls of a molded body corresponding to the draft angle of the mold used to produce it. For example, a draft angle of the exemplary shaped ceramic abrasive particle 1 in FIG. 1A would be the angle between second surface 70 and wall 84.

It is noted, as discussed herein, that the manufacturing process can introduce variation and change to final particle specifications. For example, final draft angles, side lengths, aspect ratios and thicknesses may generally fall within an expected range.

In some embodiments, an inwardly extending region of a shaped ceramic abrasive particle according to the present disclosure may have a maximum depth that is at least 5, 10, 15, 20, 25, 30, 35, 40, 45, 50, 55, or even 60 percent of the maximum dimension of the shaped ceramic abrasive particle parallel to the maximum depth. In FIG. 1A, maximum dimension 18 is parallel to maximum depth 15.

FIG. 1B illustrates another shaped abrasive particle, similar to that of FIG. 1A. Particle 100 has a first surface 102 separated from a second surface 104 by a thickness 106. As illustrated in FIG. 1B, surfaces 102 and 104 may both have curvature, and be separated by a substantially constant thickness, such that surfaces 102 and 104 can be considered to be parallel, curved, planar surfaces. As illustrated in FIG. 1B, the curvature of surfaces 102 and 104 may serve to create an edge (e.g. edge 112) that is more stable in an upright position. As described herein, an upright orientation includes a tip 114 opposite a backing 108. However, it is expressly contemplated that particle 100 may be angled with respect to backing 108, as illustrated by angle 110. In some embodiments, having a majority of shaped abrasive particles 100 angled on a backing surface causes an abrasive article to have a first cut rate, in a first direction, and a second cut rate, in a second direction. This is due to the fact that, if pulled against a surface with a concave surface (e.g. face 104) facing forward, shaped abrasive particle 100 appears like a shovel, carving out a greater amount of material from a substrate than if faced such that surface 102 faces forward.

Typically, precisely shaped abrasive particles according to the present disclosure have thicknesses that are substantially less than their length and/or width, although this is not a requirement. For example, the thickness of shaped ceramic abrasive particle may be less than or equal to one-third, one-fifth, or one-tenth of its length and/or width.

Generally, the first and second surfaces are substantially parallel, or even parallel; however, this is not a requirement. For example, random deviations due to drying may result in one or both of the first and second major surfaces being non planar. Likewise, the first and/or second major surface may have parallel grooves formed therein, for example, as described in U.S. Pat. Appln. Publ. No. 2010/0146867 A1 (Boden et al.).

Shaped ceramic abrasive particles according to the present disclosure comprise ceramic material. In some embodiments, they may consist essentially of ceramic material or even consist of ceramic material, although they may contain non-ceramic phases (e.g., as in a glass-ceramic). Examples of suitable ceramic materials include alpha alumina, fused alumina-zirconia, and fused oxynitrides. Further details concerning sol-gel derived ceramic materials suitable for use in shaped ceramic abrasive particles according to the present disclosure can be found in, for example, U.S. Pat. No. 4,314,827 (Leitheiser et al.); U.S. Pat. No. 4,518,397 (Leitheiser et al.); U.S. Pat. No. 4,623,364 (Cottringer et al.); U.S. Pat. No. 4,744,802 (Schwabel); U.S. Pat. No. 4,770,671 (Monroe et al.); U.S. Pat. No. 4,881,951 (Wood et al.); U.S. Pat. No. 4,960,441 (Pellow et al.); U.S. Pat. No. 5,139,978 (Wood); U.S. Pat. No. 5,201,916 (Berg et al.); U.S. Pat. No. 5,366,523 (Rowenhorst et al.); U.S. Pat. No. 5,429,647 (Larmie); U.S. Pat. No. 5,547,479 (Conwell et al.); U.S. Pat. No. 5,498,269 (Larmie); U.S. Pat. No. 5,551,963 (Larmie); U.S. Pat. No. 5,725,162 (Garg et al.), and U.S. Pat. No. 6,054,093 (Torre et al.).

Shaped ceramic abrasive particles according to the present disclosure are typically used as a plurality of particles that may include the shaped ceramic abrasive particles of the present disclosure, other shaped abrasive particles, and/or crushed abrasive particles. For example, a plurality of abrasive particles according to the present disclosure may comprise, on a numerical basis, at least 10, 20, 30, 40, 50, 60, 70, 80, 90, 95, or even 99 percent, or more percent of shaped ceramic abrasive particles described herein. The shaped ceramic abrasive particles may have the same nominal size and shape, although in some embodiments, it may be useful to use a combination of sizes and/or shapes.

Typically, shaped ceramic abrasive particles according to the present disclosure have a relatively small maximum particle dimension; for example, less than about 1 centimeter (cm), 5 millimeters (mm), 2 mm, 1 mm, 200 micrometers, 100 micrometers, 50 micrometers, 20 micrometers, 10 micrometers, or even less than 5 micrometers, although other sizes may be used.

Any of the abrasive particles referred to in the present disclosure may be sized according to an abrasives industry recognized specified nominal grade. Exemplary abrasive industry recognized grading standards include those promulgated by ANSI (American National Standards Institute), FEPA (Federation of European Producers of Abrasives), and JIS (Japanese Industrial Standard). Such industry accepted grading standards include, for example: ANSI 4, ANSI 6, ANSI 8, ANSI 16, ANSI 24, ANSI 30, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600; FEPA P8, FEPA P12, FEPA P16, FEPA P24, FEPA P30, FEPA P36, FEPA P40, FEPA P50, FEPA P60, FEPA P80, FEPA P100, FEPA P120, FEPA P150, FEPA P180, FEPA P220, FEPA P320, FEPA P400, FEPA P500, FEPA P600, FEPA P800, FEPA P1000, and FEPA P1200; and JIS 8, JIS 12, JIS 16, JIS 24, JIS 36, JIS 46, JIS 54, JIS 60, JIS 80, JIS 100, JIS 150, JIS 180, JIS 220, JIS 240, JIS 280, JIS 320, JIS 360, JIS 400, JIS 400, JIS 600, JIS 800, JIS 1000, JIS 1500, JIS 2500, JIS 4000, JIS 6000, JIS 8000, and JIS 10,000. More typically, the shaped ceramic abrasive particles are independently sized to ANSI 60 and 80 or FEPA P60 and P80 grading standards.

The term “abrasives industry recognized specified nominal grade” also includes abrasives industry recognized specified nominal screened grades. For example, specified nominal screened grades may use U.S.A. Standard Test Sieves conforming to ASTM E-11-09 “Standard Specification for Wire Cloth and Sieves for Testing Purposes.” ASTM E-11-09 sets forth requirements for the design and construction of testing sieves using a medium of woven wire cloth mounted in a frame for the classification of materials according to a designated particle size. A typical designation may be represented as −18+20, meaning that the shaped ceramic abrasive particles pass through a test sieve meeting ASTM E11-09 “Standard Specification for Woven Wire Test Sieve Cloth and Test Sieves” specifications for the number 18 sieve and are retained on a test sieve meeting ASTM E11-09 specifications for the number 20 sieve. In one embodiment, the shaped ceramic abrasive particles have a particle size such that at least 90 percent of the particles pass through an 18 mesh test sieve and can be retained on a 20, 25, 30, 35, 40, 45, or 50 mesh test sieve. In various embodiments, the shaped ceramic abrasive particles can have a nominal screened grade comprising: −18+20 −20/+25, −25+30, −30+35, −35+40, 5 −40+45, −45+50, −50+60, −60+70, −70/+80, −80+100, −100+120, −120+140, −140+170, −170+200, −200+230, −230+270, −270+325, −325+400, −400+450, −450+500, or −500+635.

In some embodiments, shaped ceramic abrasive particles can be made according to a multistep process. The process can be carried out using a ceramic precursor dispersion (e.g., a dispersion (e.g., a sol-gel) comprising a ceramic precursor material).

Briefly, the method comprises the steps of making either a seeded or non-seeded ceramic precursor dispersion that can be converted into a corresponding ceramic (e.g., a boehmite sol-gel that can be converted to alpha alumina); filling one or more mold cavities having the desired outer shape of the shaped abrasive particle with a ceramic precursor dispersion, drying the ceramic precursor dispersion to form shaped ceramic precursor particles; removing the shaped ceramic precursor particles from the mold cavities; calcining the shaped ceramic precursor particles to form calcined, shaped ceramic precursor particles, and then sintering the calcined, shaped ceramic precursor particles to form shaped ceramic abrasive particles.

In some embodiments, the calcining step is omitted and the shaped ceramic precursor particles are sintered directly after removal from the mold. In some embodiments, the mold may be made of a sacrificial material (e.g., a polyolefin material) that is burned off during calcining or sintering, thereby eliminating the need to separate the ceramic precursor particles from it during processing.

The process will now be described in greater detail in the context of alpha-alumina-containing shaped ceramic abrasive particles.

The first process step involves providing either a seeded or non-seeded dispersion of a ceramic precursor material (i.e., a ceramic precursor dispersion) that can be converted into a ceramic material. The ceramic precursor dispersion often comprises a volatile liquid component. In one embodiment, the volatile liquid component is water. The ceramic precursor dispersion should comprise a sufficient amount of liquid for the viscosity of the dispersion to be sufficiently low to enable filling mold cavities and replicating the mold surfaces, but not so much liquid as to cause subsequent removal of the liquid from the mold cavity to be prohibitively expensive. In one embodiment, the ceramic precursor dispersion comprises from 2 to 90 percent by weight of the particles that can be converted into ceramic, such as particles of aluminum oxide monohydrate (boehmite) or another alumina precursor, and at least 10 to 98 percent by weight, or from 50 to 70 percent by weight, or 50 to 60 percent by weight, of the volatile component such as water. Conversely, the ceramic precursor dispersion in some embodiments contains from 30 to 50 percent, or 40 to 50 percent by weight solids.

Examples of useful ceramic precursor dispersions include zirconium oxide sols, vanadium oxide sols, cerium oxide sols, aluminum oxide sols, and combinations thereof. Useful aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL”, and “DISPAL”, both available from Sasol North America, Inc. or “HIQ-40” available from BASF Corporation. These aluminum oxide monohydrates are relatively pure; that is, they include relatively little, if any, hydrate phases other than monohydrates, and have a high surface area.

Other examples of suitable ceramic precursor materials include non-colloidal alumina slurries, as described in U.S. Pat. No. 10,400,146 issued Sep. 3, 2019 (Rosenflanz et al.).

The physical properties of the resulting shaped ceramic abrasive particles will generally depend upon the type of material used in the ceramic precursor dispersion. As used herein, a “gel” is a three dimensional network of solids dispersed in a liquid.

The ceramic precursor dispersion may contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, typically water soluble salts. They typically consist of a metal-containing compound and can be a precursor of oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the ceramic precursor dispersion can be varied based on skill in the art.

Typically, the introduction of a modifying additive or precursor of a modifying additive will cause the ceramic precursor dispersion to gel. The ceramic precursor dispersion can also be induced to gel by application of heat over a period of time to reduce the liquid content in the dispersion through evaporation. The ceramic precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina. Nucleating alpha alumina precursor dispersions is disclosed in U.S. Pat. No. 4,744,802 (Schwabel).

A peptizing agent can be added to the ceramic precursor dispersion to produce a more stable hydrosol or colloidal ceramic precursor dispersion. Suitable peptizing agents are monoprotic acids or acid compounds such as acetic acid, hydrochloric acid, formic acid, and nitric acid. Multiprotic acids can also be used but they can rapidly gel the ceramic precursor dispersion, making it difficult to handle or to introduce additional components thereto. Some commercial sources of boehmite contain an acid titer (such as absorbed formic or nitric acid) that will assist in forming a stable ceramic precursor dispersion.

The ceramic precursor dispersion can be formed by any suitable means; for example, in the case of a sol-gel alumina precursor by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

The second process step involves providing a mold having at least one mold cavity, and preferably a plurality of cavities formed in at least one major surface of the mold.

In some embodiments, the mold is formed as a production tool, which can be, for example, a belt, a sheet, a continuous web, a coating roll such as a rotogravure roll, a sleeve mounted on a coating roll, or a die. In one embodiment, the production tool comprises polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one embodiment, the entire tooling is made from a polymeric or thermoplastic material. In another embodiment, the surfaces of the tooling in contact with the ceramic precursor dispersion while drying, such as the surfaces of the plurality of cavities, comprises polymeric or thermoplastic materials and other portions of the tooling can be made from other materials. A suitable polymeric coating may be applied to a metal tooling to change its surface tension properties by way of example.

A polymeric or thermoplastic production tool can be replicated off a metal master tool. The master tool will have the inverse pattern desired for the production tool. The master tool can be made in the same manner as the production tool. In one embodiment, the master tool is made out of metal, e.g., nickel and is diamond turned. In one embodiment, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that may distort the thermoplastic production tool limiting its life. More information concerning the design and fabrication of production tooling or master tools can be found in U.S. Pat. No. 5,152,917 (Pieper et al.); U.S. Pat. No. 5,435,816 (Spurgeon et al.); U.S. Pat. No. 5,672,097 (Hoopman et al.); U.S. Pat. No. 5,946,991 (Hoopman et al.); U.S. Pat. No. 5,975,987 (Hoopman et al.); and U.S. Pat. No. 6,129,540 (Hoopman et al.).

Access to cavities can be from an opening in the top surface or bottom surface of the mold. In some instances, the cavities can extend for the entire thickness of the mold. Alternatively, the cavities can extend only for a portion of the thickness of the mold. In one embodiment, the top surface is substantially parallel to bottom surface of the mold with the cavities having a substantially uniform depth. At least one edge of the mold, that is, the edge in which the cavities are formed, can remain exposed to the surrounding atmosphere during the step in which the volatile component is removed.

The cavities have a specified three-dimensional shape to make the shaped ceramic abrasive particles. The depth dimension is equal to the perpendicular distance from the top surface to the lowermost point on the bottom surface. The depth of a given cavity can be uniform or can vary along its length and/or width. The cavities of a given mold can be of the same shape or of different shapes.

The third process step involves filling the cavities in the mold with the ceramic precursor dispersion (e.g., by a conventional technique). In some embodiments, a knife roll coater or vacuum slot die coater can be used. A mold release can be used to aid in removing the particles from the mold if desired. Typical mold release agents include oils such as peanut oil or mineral oil, fish oil, silicones, polytetrafluoroethylene, zinc stearate, and graphite. In general, mold release agent such as peanut oil, in a liquid, such as water or alcohol, is applied to the surfaces of the production tooling in contact with the ceramic precursor dispersion such that between about 0.1 mg/in² (0.02 mg/cm²) to about 3.0 mg/in² (0.5 mg/cm²), or between about 0.1 mg/in² (0.02 mg/cm²) to about 5.0 mg/in² (0.8 mg/cm²) of the mold release agent is present per unit area of the mold when a mold release is desired. In some embodiments, the top surface of the mold is coated with the ceramic precursor dispersion. The ceramic precursor dispersion can be pumped onto the top surface.

Next, a scraper or leveler bar (i.e., a screed) can be used to force the ceramic precursor dispersion fully into the cavity of the mold. The remaining portion of the ceramic precursor dispersion that does not enter cavity can be removed from top surface of the mold and recycled. In some embodiments, a small portion of the ceramic precursor dispersion can remain on the top surface and in other embodiments the top surface is substantially free of the dispersion. The pressure applied by the scraper or leveler bar is typically less than 100 psi (0.7 MPa), less than 50 psi (0.3 MPa), or even less than 10 psi (69 kPa). In some embodiments, no exposed surface of the ceramic precursor dispersion extends substantially beyond the top surface.

In those embodiments, wherein it is desired to have the exposed surfaces of the cavities result in substantially planar faces of the shaped ceramic abrasive particles, it may be desirable to overfill the cavities (e.g., using a micronozzle array) and slowly dry the ceramic precursor dispersion.

The fourth process step involves removing the volatile component to dry the dispersion. Desirably, the volatile component is removed by fast evaporation rates. In some embodiments, removal of the volatile component by evaporation occurs at temperatures above the boiling point of the volatile component. An upper limit to the drying temperature often depends on the material the mold is made from. For polypropylene tooling the temperature should be less than the melting point of the plastic. In one embodiment, for a water dispersion of between about 40 to 50 percent solids and a polypropylene mold, the drying temperatures can be between about 90° C. to about 165° C., or between about 105° C. to about 150° C., or between about 105° C. to about 120° C. Higher temperatures can lead to improved production speeds but can also lead to degradation of the polypropylene tooling limiting its useful life as a mold.

The fifth process step involves removing resultant shaped ceramic precursor particles from the mold cavities. The shaped ceramic precursor particles can be removed from the cavities by using the following processes alone or in combination on the mold: gravity, vibration, ultrasonic vibration, vacuum, or pressurized air to remove the particles from the mold cavities.

The shaped ceramic precursor particles can be further dried outside of the mold. If the ceramic precursor dispersion is dried to the desired level in the mold, this additional drying step is not necessary. However, in some instances it may be economical to employ this additional drying step to minimize the time that the ceramic precursor dispersion resides in the mold. Typically, the shaped ceramic precursor particles will be dried from 10 to 480 minutes, or from 120 to 400 minutes, at a temperature from 50° C. to 160° C., or at 120° C. to 150° C.

The sixth process step involves calcining the shaped ceramic precursor particles. During calcining, essentially all the volatile material is removed, and the various components that were present in the ceramic precursor dispersion are transformed into metal oxides. The shaped ceramic precursor particles are generally heated to a temperature from 400° C. to 800° C., and maintained within this temperature range until the free water and over 90 percent by weight of any bound volatile material are removed. In an optional step, it may be desired to introduce the modifying additive by an impregnation process. A water-soluble salt can be introduced by impregnation into the pores of the calcined, shaped ceramic precursor particles. Then the shaped ceramic precursor particles are pre-fired again. This option is further described in U.S. Pat. No. 5,164,348 (Wood).

The seventh process step involves sintering the calcined, shaped ceramic precursor particles to form ceramic particles. Prior to sintering, the calcined, shaped ceramic precursor particles are not completely densified and thus lack the desired hardness to be used as shaped ceramic abrasive particles. Sintering takes place by heating the calcined, shaped ceramic precursor particles to a temperature of from 1000° C. to 1650° C. The length of time to which the calcined, shaped ceramic precursor particles must be exposed to the sintering temperature to achieve this level of conversion depends upon various factors but usually from five seconds to 48 hours is typical.

In another embodiment, the duration for the sintering step ranges from one minute to 90 minutes. After sintering, the shaped ceramic abrasive particles can have a Vickers hardness of 10 GPa (gigapascals), 16 GPa, 18 GPa, 20 GPa, or greater.

Other steps can be used to modify the described process such as, for example, rapidly heating the material from the calcining temperature to the sintering temperature, centrifuging the ceramic precursor dispersion to remove sludge and/or waste. Moreover, the process can be modified by combining two or more of the process steps if desired. Conventional process steps that can be used to modify the process of this disclosure are more fully described in U.S. Pat. No. 4,314,827 (Leitheiser).

Shaped ceramic abrasive particles composed of crystallites of alpha alumina, magnesium alumina spinel, and a rare earth hexagonal aluminate may be prepared using sol-gel alpha alumina precursor particles according to methods described in, for example, U.S. Pat. No. 5,213,591 (Celikkaya et al.) and U.S. Publ. Pat. Appl. Nos. 2009/0165394 A1 (Culler et al.) and 2009/0169816 A1 (Erickson et al.). Alpha alumina abrasive particles may contain zirconia as disclosed in U.S. Pat. No. 5,551,963 (Larmie). Alternatively, alpha alumina abrasive particles may have a microstructure or additives, for example, as disclosed in U.S. Pat. No. 6,277,161 (Castro). More information concerning methods to make shaped ceramic abrasive particles is disclosed in co-pending U.S. Publ. Patent Appln. No. 2009/0165394 A1 (Culler et al.).

Surface coatings on the shaped ceramic abrasive particles may be used to improve the adhesion between the shaped ceramic abrasive particles and a binder material in abrasive articles, or can be used to aid in electrostatic deposition of the shaped ceramic abrasive particles. In one embodiment, surface coatings as described in U.S. Pat. No. 5,352,254 (Celikkaya) in an amount of 0.1 to 2 percent surface coating to shaped abrasive particle weight may be used. Such surface coatings are described in U.S. Pat. No. 5,213,591 (Celikkaya et al.); U.S. Pat. No. 5,011,508 (Wald et al.); U.S. Pat. No. 1,910,444 (Nicholson); U.S. Pat. No. 3,041,156 (Rowse et al.); U.S. Pat. No. 5,009,675 (Kunz et al.); U.S. Pat. No. 5,085,671 (Martin et al.); U.S. Pat. No. 4,997,461 (Markhoff-Matheny et al.); and U.S. Pat. No. 5,042,991 (Kunz et al.). Additionally, the surface coating may prevent the shaped abrasive particle from capping. Capping is the term to describe the phenomenon where metal particles from the workpiece being abraded become welded to the tops of the shaped ceramic abrasive particles. Surface coatings to perform the above functions are known to those of skill in the art.

The shaped ceramic abrasive particles of the present disclosure can typically be made using tools (or molds that are inverse replicas thereof) cut using diamond tooling, which provides higher feature definition than other fabrication alternatives such as, for example, stamping or punching. Typically, the cavities in the tool surface have smooth faces that meet along sharp edges, although this is not a requirement. The resultant shaped ceramic abrasive particles have a respective nominal average shape that corresponds to the shape of cavities in the tool surface; however, variations (e.g., random variations) from the nominal average shape may occur during manufacture, and shaped ceramic abrasive particles exhibiting such variations are included within the definition of shaped ceramic abrasive particles as used herein.

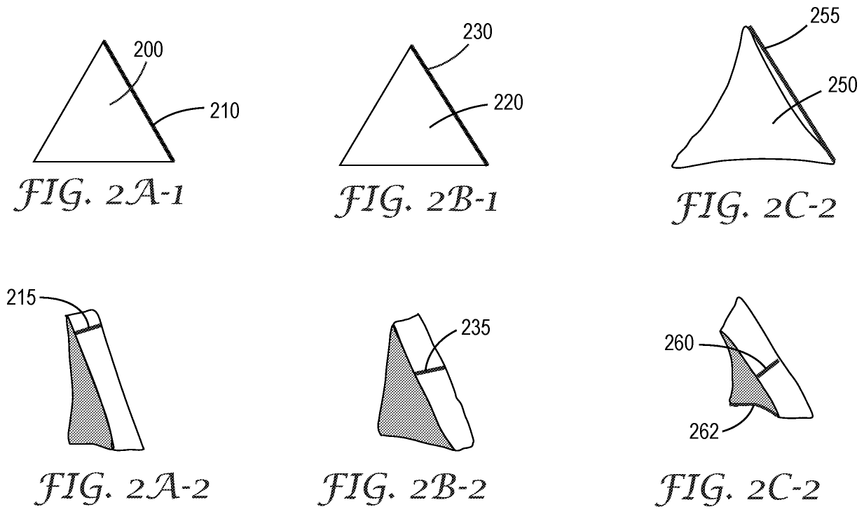

FIGS. 2A-2C illustrate different shaped abrasive particles that may be used to form abrasive articles. FIGS. 2A-1 and 2A-2 illustrates a triangular shaped abrasive particle 200 with a side length 210 and thickness 215. Particle 200 is made using a mold with an aspect ratio of 4:1 (side length 210 being four times longer than thickness 215). FIG. 2B-1 and 2B-2 illustrates a triangular shaped abrasive particle 220 with a side length 230 and thickness 235. Particle 220 is made using a mold with an aspect ratio of 3:1 (side length 230 is three times the thickness 235). However, it is noted that the final aspect ratio of fired particles varies due to manufacturing processes, as illustrated in Table 1 below.

FIGS. 2C-1 and 2C-2 illustrate a particle 250 that has three sides, each with concave curvature. As illustrated in FIG. 2C-2, the concave curvature of each side 255 may, as a result of the particle drying process, cause some shrinkage to produce a curvature 262 along the edges.- Particle 250 is made using a mold with an aspect ratio of 7:2 (with the side length 255 being 3.5 times the length of thickness 260).

Table 1 below illustrates some example parameter ranges for particles 200, 220 and 250. As noted, a final Particle EQ5: 1 is not illustrated in FIGS. 2A-2C, but the ranges included are illustrative of an equilateral triangle shaped particle similar to particles 200 and 220, but from a mold having an aspect ratio of 5:1.

TABLE 1
Particle Parameter Ranges

| | | | Aspect Ratio | | |
|---|---|---|---|---|---|
| | Side Length | | (fired) | | Example of Actual |
| | Lower | Upper | Lower | Upper | Measured Aspect |
| Particle | Bound | Bound | Bound | Bound | Ratio |
| 200 | 1275 | 1525 | 4.75:1 | 6.25:1 | 5.27 |
| 220 | 1275 | 1525 | 3:1 | 4.5:1 | 3.62 |
| 250 | 1275 | 1525 | 3.75:1 | 5.25:1 | 4.43 |
| EQ5:1 | 1275 | 1525 | 5.25:1 | 6.75:1 | 6.12 |

As illustrated in Table 1, the aspect ratio of fired particles in embodiments herein may range from 3:1 to 7:1, or from 3:1 to 6:1, in some embodiments. In some further embodiments, the aspect ratio of particles described in embodiments herein may range from 3.5:1 to 5.5:1. FIG. 3 illustrates a method of forming an abrasive article in accordance with embodiments herein.

Shaped ceramic abrasive particles are useful, for example, in the construction of abrasive articles, including for example, coated abrasive articles (for example, conventional make and size coated abrasive articles, slurry coated abrasive articles, and structured abrasive articles). In general, abrasive articles comprise a plurality of abrasive particles retained in a binder. FIG. 3 illustrates a method of manufacturing a coated abrasive article in accordance with embodiments described herein. Method 300 may be used, for example, to make any of the coated abrasive articles discussed herein. However, it can also be used to make other suitable coated abrasive articles.

In block 310, a backing is provided. The backing may have a pre-treatment prior to the coating process, in some embodiments. Pre-treatments may help increase adhesion, reduce abrasive weight loss, or reduce static, for example. The provided backing may also be untreated, in other embodiments. The backing may also have other features as well, such as perforations, laminate layers, etc. The backing may be flexible or stiff, and may be made from any suitable woven or nonwoven material.

In block 320, a make coat is provided. The make coat is typically provided in an uncured form such that deposited abrasive particles can embed. The make coat can be deposited on the backing in any number of suitable manners including, for example, spray coating, roll-coating, knife coating, etc.

In block 330, abrasive particles are embedded within the make coat. As described herein for comparative purposes, abrasive particles 200, 220 and 250 were all used to make abrasive articles, described in the Examples herein. However, it is expressly contemplated that other shapes may be used. Abrasive articles are embedded at a coat weight 336, which refers to an average number of particles on an abrasive article, often expressed as particles per square inch.

It was surprisingly noted by the inventors that abrasive belts made with abrasive particles 250 at a coat weight of over 400 particles per square inch exhibited good abrasive behavior along a wide range of pressures. Generally, it is expected that a high coat weight will perform well at high pressure applications, but not at medium or low pressures. However, abrasive belts made with abrasive particles 250 at high coat weights had better than expected cut rates across a wide range of applied pressures.

Additionally, it is also noted that high coat weight belts made with abrasive particles 250 showed high peak count (correct orientation), high cut rate and low abrasive weight loss. It is difficult to balance all three of those parameters.

It was also surprising to see that the same particle, when used at low coat weight, also illustrated higher cut rate and lower abrasive weight loss than expected. Generally, it is expected that lower coat weight applications will not perform well at high pressures as the particles will break down too quickly.

The first set of abrasive particles may be deposited and oriented on the backing using any suitable method, such as using electrostatic alignment, which orients the particles in an X-Y direction, but not in a Z direction. Alternatively, the first set of abrasive particles may be deposited and oriented using magnetic alignment in embodiments where the abrasive particles include a magnetically responsive element or coating such that the particles, when exposed to a magnetic field, will orient in a desired orientation.

Orienting may include orienting the abrasive particles such that corresponding faces of nearby particles are parallel to one another, as indicated in block 332, and such that a sharp tip or edge is facing away from the backing, as indicated in block 334. Alignment of abrasive particles may be accomplished using electrostatic coating or magnetic coating, as described in PCT Pat. Appl. Publ. Nos. WO2018/080703 (Nelson et al.), WO2018/080756(Eckel et al.), WO2018/080704 (Eckel et al.), WO2018/080705 (Adefris et al.), WO2018/080765 (Nelson et al.), WO2018/080784 (Eckel et al.), WO2018/136271 (Eckel et al.), WO2018/134732 (Nienaber et al.), WO2018/080755 (Martinez et al.), WO2018/080799 (Nienaber et al.), WO2018/136269 (Nienaber et al.), WO2018/136268 (Jesme et al.), WO2019/207415 (Nienaber et al.), WO2019/207417 (Eckel et al.), WO2019/207416 (Nienaber et al.), and U.S. Provisional Nos. 62/914,778 filed on Oct. 14, 2019 and 62/875,700 filed Jul. 18, 2019, and 62/924,956, filed Oct. 23, 2019.

Making particles magnetically responsive may include coating non-magnetically responsive particles with a magnetically responsive coating. However, in other embodiments, the particles are formed with magnetically responsive material, for example as recited in co-owned provisional patent U.S. 62/914778, filed on Oct. 14, 2019. At least one magnetic material may be included within or coated to shaped abrasive particle. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu2MnSn); manganese bismuthide (also known as Bismanol); rare earth magnetizable materials such as gadolinium, dysprosium, holmium, europium oxide, alloys of neodymium, iron and boron (e.g., Nd2Fe14B), and alloys of samarium and cobalt (e.g., SmCo5); MnSb; MnOFe2O3; Y3Fe5O12; CrO2; MnAs; ferrites such as ferrite, magnetite; zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 100 using a vapor deposition technique such as, for example, physical vapor deposition (PVD) including magnetron sputtering. Including these magnetizable materials can allow shaped abrasive particle to be responsive a magnetic field. Any of shaped abrasive particles can include the same material or include different materials.

The magnetic coating may be a continuous coating, for example that coats an entire abrasive particle, or at least coats an entire surface of an abrasive particle. In another embodiment, a continuous coating refers to a coating present with no uncoated portions on the coated surface. In one embodiment, the coating is a unitary coating—formed of a single layer of magnetic material and not as discrete magnetic particulates. In one embodiment, the magnetic coating is provided on an abrasive particle while the particle is still in a mold cavity, such that the magnetic coating directly contacts an abrasive particle precursor surface. In one embodiment, the thickness of the magnetic coating is at most equal to, or preferably less than, a thickness of the abrasive particle. In one embodiment, the magnetic coating is not more than about 20 wt. % of the final particle, or not more than about 10 wt. % of the final particle, or not more than 5 wt. % of the final particle.

Magnetically aligning the abrasive particles with respect to each other generally requires two steps. First, providing the magnetizable abrasive particles described herein on a substrate having a major surface. Second, applying a magnetic field to the magnetizable abrasive particles such that a majority of the magnetizable abrasive particles are oriented substantially perpendicular to the major surface. Without application of a magnetic field, the resultant magnetizable abrasive particles may not have a magnetic moment, and the constituent abrasive particles, or magnetizable abrasive particles may be randomly oriented. However, when a sufficient magnetic field is applied the magnetizable abrasive particles will tend to align with the magnetic field. In favored embodiments, the ceramic particles have a major axis (e.g. aspect ratio of 2) and the major axis aligns parallel to the magnetic field. Preferably, a majority or even all of the magnetizable abrasive particles will have magnetic moments that are aligned substantially parallel to one another. As described above, abrasive particles described herein may have more than one magnetic moment and will align with a net magnetic torque.

The magnetic field can be supplied by any external magnet (e.g., a permanent magnet or an electromagnet) or set of magnets. In some embodiments, the magnetic field typically ranges from 0.5 to 1.5 kOe. Preferably, the magnetic field is substantially uniform on the scale of individual magnetizable abrasive particles.

For production of abrasive articles, a magnetic field can optionally be used to place and/or orient the magnetizable abrasive particles prior to curing a binder (e.g., vitreous or organic) precursor to produce the abrasive article. The magnetic field may be substantially uniform over the magnetizable abrasive particles before they are fixed in position in the binder or continuous over the entire, or it may be uneven, or even effectively separated into discrete sections. Typically, the orientation of the magnetic field is configured to achieve alignment of the magnetizable abrasive particles according to a predetermined orientation, for example such that abrasive particles are parallel to each other and have cutting faces facing in a downweb direction.

Examples of magnetic field configurations and apparatuses for generating them are described in U.S. Pat. No. 8,262,758 (Gao) and U.S. Pat. No. 2,370,636 (Carlton), U.S. Pat. No. 2,857,879 (Johnson), U.S. Pat. No. 3,625,666 (James), U.S. Pat. No. 4,008,055 (Phaal), U.S. Pat. No. 5,181,939 (Neff), and British (G.B.) Pat. No. 1 477 767 (Edenville Engineering Works Limited).

Orientation, as illustrated in blocks 332 and 335 may also be achieved using patterned drop coating. In some embodiments, patterned drop coating can be achieved using an alignment tool by methods analogous to that described in PCT Pat. Appl. Publ. Nos. 2016/205133 (Wilson et al.), 2016/205267 (Wilson et al.), 2017/007703 (Wilson et al.), 2017/007714 (Liu et al.). The method generally involves the steps of filling the cavities in a production tool each with one or more triangular abrasive particles (typically one or two), aligning the filled production tool and a make layer precursor-coated backing for transfer of the triangular abrasive particles to the make layer precursor, transferring the abrasive particles from the cavities onto the make layer precursor-coated backing, and removing the production tool from the aligned position. Thereafter, the make layer precursor is at least partially cured (typically to a sufficient degree that the triangular abrasive particles are securely adhered to the backing), a size layer precursor is then applied over the make layer precursor and abrasive particles, and at least partially cured to provide the coated abrasive belt. The process, which may be batch or continuous, can be practiced by hand or automated, e.g., using robotic equipment. It is not required to perform all steps or perform them in consecutive order, but they can be performed in the order listed or additional steps performed in between. The triangular abrasive particles can be placed in the desired Z-axis rotational orientation formed by first placing them in appropriately shaped cavities in a dispensing surface of a production tool arranged to have a complementary rectangular grid pattern, or other suitable pattern based on the shape of the abrasive particles.

Transfer coating using a tool having patterned cavities can be analogous to that described in U.S. Pat. Appln. Publ. No. 2016/0311081 A1 (Culler et al.). In some embodiments, abrasive particles can be applied onto the make layer through a patterned mesh or sieve.

Abrasive particles may also have other features 338.

Examples of suitable abrasive particles include: fused aluminum oxide; heat-treated aluminum oxide; white fused aluminum oxide; ceramic aluminum oxide materials such as those commercially available under the trade designation 3M CERAMIC ABRASIVE GRAIN from 3M Company, St. Paul, MN; brown aluminum oxide; blue aluminum oxide; silicon carbide (including green silicon carbide); titanium diboride; boron carbide; tungsten carbide; garnet; titanium carbide; diamond; cubic boron nitride; garnet; fused alumina zirconia; iron oxide; chromia; zirconia; titania; tin oxide; quartz; feldspar; flint; emery; sol-gel-derived abrasive particles; and combinations thereof. Of these, molded sol-gel derived alpha alumina abrasive particles are preferred in many embodiments. Abrasive material that cannot be processed by a sol-gel route may be molded with a temporary or permanent binder to form shaped precursor particles which are then sintered to form shaped abrasive particles, for example, as described in U. S. Pat. Appln. Publ. No. 2016/0068729 A1 (Erickson et al.).

Examples of sol-gel-derived abrasive particles and methods for their preparation can be found in U. S. Pat. No. 4,314,827 (Leitheiser et al.); U.S. Pat. No. 4,623,364 (Cottringer et al.); U.S. Pat. No. 4,744,802 (Schwabel), U.S. Pat. No. 4,770,671 (Monroe et al.); and U.S. Pat. No. 4,881,951 (Monroe et al.). It is also contemplated that the abrasive particles could include abrasive agglomerates such, for example, as those described in U. S. Pat. No. 4,652,275 (Bloecher et al.) or U.S. Pat. No. 4,799,939 (Bloecher et al.). In some embodiments, first and/or abrasive particles may be surface-treated with a coupling agent (e.g., an organosilane coupling agent) or other physical treatment (e.g., iron oxide or titanium oxide) to enhance adhesion of the abrasive particles to the binder (e.g., make and/or size layer). The abrasive particles may be treated before combining them with the corresponding binder precursor, or they may be surface treated in situ by including a coupling agent to the binder.

Preferably, abrasive particles are ceramic abrasive particles such as, for example, sol-gel-derived polycrystalline alpha alumina particles. Abrasive particles composed of crystallites of alpha alumina, magnesium alumina spinel, and a rare earth hexagonal aluminate may be prepared using sol-gel precursor alpha alumina particles according to methods described in, for example, U. S. Pat. No. 5,213,591 (Celikkaya et al.) and U. S. Pat. Appln. Publ. Nos. 2009/0165394 A1 (Culler et al.) and 2009/0169816 A1 (Erickson et al.).

Alpha alumina-based shaped abrasive particles can be made according to well-known multistep processes. Briefly, the method includes the steps of making either a seeded or non-seeded sol-gel alpha alumina precursor dispersion that can be converted into alpha alumina; filling one or more mold cavities having the desired outer shape of the abrasive particle with the sol-gel, drying the sol-gel to form precursor triangular abrasive particles; removing the precursor abrasive particles from the mold cavities; calcining the precursor abrasive particles to form calcined, precursor abrasive particles, and then sintering the calcined, precursor abrasive particles to form the first and/or second set of abrasive particles. The process will now be described in greater detail.

Further details concerning methods of making sol-gel-derived abrasive particles can be found in, for example, U. S. Pat. No. 4,314,827 (Leitheiser); U.S. Pat. No. 5,152,917 (Pieper et al.); U.S. Pat. No. 5,435,816 (Spurgeon et al.); U.S. Pat. No. 5,672,097 (Hoopman et al.); U.S. Pat. No. 5,946,991 (Hoopman et al.); U.S. Pat. No. 5,975,987 (Hoopman et al.); and U.S. Pat. No. 6,129,540 (Hoopman et al.); and in U. S. Publ. Pat. Appln. No. 2009/0165394 A1 (Culler et al.).

Examples of slurry derived alpha alumina abrasive particles can be found in WO 2014/070468, published on May 8, 2014. Slurry derived particles may be formed from a powder precursor, such as alumina oxide powder. The slurry process may be advantageous for larger particles that can be difficult to make using sol-gel techniques.

The abrasive particles may undergo a sintering process, such as the process described in U.S. Pat. 10400146, issued on Sep. 3, 2019, for example. However, other processing techniques are expressly contemplated.

Ultra-fine grain shaped grains may be formed using techniques described in U.S. PAP 2019/0233693, published on Aug. 1, 2019, or in WO 2018023177, published on Dec. 20, 2018, or in WO 2018/207145, published on Nov. 15, 2018.

Softer shaped grain particles, with Mohs hardness' between 2.0 and 5.0, that can be used for non-scratch applications, can be made according to methods described in WO 2019/215539, published on Nov. 14, 2019.

In some preferred embodiments, the abrasive particles are precisely-shaped in that individual abrasive particles will have a shape that is essentially the shape of the portion of the cavity of a mold or production tool in which the particle precursor was dried, prior to optional calcining and sintering.

Abrasive particles used in the present disclosure can typically be made using tools (i.e., molds) cut using precision machining, which provides higher feature definition than other fabrication alternatives such as, for example, stamping or punching.

The shaped abrasive particles can have at least one sidewall, which may be a sloping sidewall. In some embodiments, more than one (for example two or three) sloping sidewall can be present and the slope or angle for each sloping sidewall may be the same or different. In other embodiments, the sidewall can be minimized for particles where the first and the second faces taper to a thin edge or point where they meet instead of having a sidewall. The sloping sidewall can also be defined by a radius, R (as illustrated in FIG. 5B of US Patent Application No. 2010/0151196). The radius, R, can be varied for each of the sidewalls.

Specific examples of shaped particles having a ridge line include roof-shaped particles, for example particles as illustrated, in FIG. 4A to 4C of WO 2011/068714. Preferred, roof-shaped particles include particles having the shape of a hip roof, or hipped roof (a type of roof wherein any sidewalls facets present slope downwards from the ridge line to the first side. A hipped roof typically does not include vertical sidewall(s) or facet(s)).

Methods for making shaped abrasive particles having at least one sloping sidewall are for example described in US Patent Application Publication No. 2009/0165394.

Shaped abrasive particles can also include a plurality of ridges on their surfaces. The plurality of grooves (or ridges) can be formed by a plurality of ridges (or grooves) in the bottom surface of a mold cavity that have been found to make it easier to remove the precursor shaped abrasive particles from the mold.

The plurality of grooves (or ridges) is not particularly limited and can, for example, include parallel lines which may or may not extend completely across the side. Preferably, the parallel lines intersect with the perimeter along a first edge at a 90° angle. The cross-sectional geometry of a groove or ridge can be a truncated triangle, triangle, or other geometry as further discussed in the following. In various embodiments of the invention, the depth of the plurality of grooves can be between about 1 micrometer to about 400 micrometers.

According to another embodiment the plurality of grooves include a cross hatch pattern of intersecting parallel lines which may or may not extend completely across the face. In various embodiments, the cross hatch pattern can use intersecting parallel or non-parallel lines, various percent spacing between the lines, arcuate intersecting lines, or various cross-sectional geometries of the grooves. In other embodiments the number of ridges (or grooves) in the bottom surface of each mold cavity can be between 1 and about 100, or between 2 to about 50, or between about 4 to about 25 and thus form a corresponding number of grooves (or ridges) in the shaped abrasive particles.

Methods for making shaped abrasive particles having grooves on at least one side are for example described in US Patent Application Publication No. 2010/0146867.

The shaped abrasive particles may also have one or more notches on one of the faces of the abrasive particle, as described in PCT Application Ser. No. IB2019/060861, filed on Dec. 16, 2019.

Shaped abrasive particles can have an opening (preferably one extending or passing through the first and second side). Methods for making shaped abrasive particles having an opening are for example described in US Patent Application Publication No. 2010/0151201 and 2009/0165394.

Shaped abrasive particles can also have at least one recessed (or concave) face or facet; at least one face or facet which is shaped outwardly (or convex). Methods for making dish-shaped abrasive particles are for example described in US Patent Application Publication Nos. 2010/0151195 and 2009/0165394. Additionally, shaped abrasive particles may also have a multifaceted surface as described in U.S. Pat. No. 10,150,900, issued on Dec. 11, 2018.

Shaped abrasive particles can also have at least one fractured surface. Methods for making shaped abrasive particles with at least one fractured surface are for example described in US Patent Application Publication Nos. 2009/0169816 and 2009/0165394.

Shaped abrasive particles can also have a cavity. Shaped abrasive particles may also include an aperture, such as that described in U.S. Pat. 8,142,532, issued on Mar. 27, 2012, herein incorporated by reference.

Shaped abrasive particles can also have a low roundness factor. Methods for making shaped abrasive particles with low Roundness Factor are for example described in US Patent Application Publication No. 2010/0319269.

Shaped abrasive particles may have a second vertex on a second side, as described in U.S. Pat. No. 9,447,311, issued on Sep. 16, 2016. Methods for making abrasive particles wherein the second side is a vertex (for example, dual tapered abrasive particles) or a ridge line (for example, roof shaped particles) are for example described in U.S. PAP 2012/022733, published on Sep. 13, 2012.

Shaped abrasive particles may be formed to have sharp tips, such as those described in U.S. PAP 2019/0233693, published on Aug. 1, 2019, or in U.S. Provisional Application with Ser. No. 62/877,443, filed on Jul. 23, 2019.

Shaped abrasive particles may also be formed to include a rake angle, such as those described in WO 2019/207423, published on Oct. 31, 2019, or in WO 2019/207417, published on Oct. 31, 2019, or in PCT Application Ser. No. IB 2019/059112, filed on Oct. 24, 2019.

Shaped abrasive particles may also be formed to have a precision shaped portion and a non-shaped portion, such as a crushed portion, as described in U.S. Provisional Patent Application 62/833,865, filed on Apr. 15, 2019.

Shaped abrasive particles can also have a combination of one or more of shape features discussed herein, including a sloping sidewall, a groove, a recess, a facet, a fractured surface, a cavity, more than one vertex, sharp edges, a non-shaped portion, a notch, a rake angle and/or a low roundness factor.

The shaped abrasive particles may have an elongated shape, such as that described in U.S. PAP 2019/0106362, published on Apr. 11, 2019, or in WO 2019/069157, published on Apr. 11, 2019. The elongate shape may be triangular-prism shaped, rod-shaped, or otherwise including one or more vertices along the perimeter.

The shaped abrasive particles may have a variable cross-sectional area along a length of the particle, such as those described in U.S. PAP 2019/0249051. For example, the shaped abrasive particles may be dogbone shaped, or otherwise have a cross sectional area that varies from a first end to a second end.

The shaped abrasive particles may have a tetrahedron shape, such as those described in WO 2018/207145, published on Nov. 15, 2018, or those of U.S. Pat. No. 9,573,250, issued on Feb. 21, 2017.

The shaped abrasive particles may also have a concave or convex portion, or may be defined as having one or more acute interior angles, such as those described in U.S. Pat. No. 10,301,518, issued on May 28, 2019.

The shaped abrasive particles may also include shape-on-shape particles, such as a plate on plate shaped particle as described in U.S. Pat. No. 8,728,185, issued on May 20, 2014.

The shaped abrasive particles may also include shaped abrasive particles that have an irregular polygonal shape, as described in U.S. Provisional Patent Application 62/924,956, filed on Oct. 23, 2019.

The shaped abrasive particles may also be shaped to be self-standing abrasive particles, such that cutting portions are more likely to embed in a make coat, for example, in an orientation away from the backing, such as those described in PCT Application with Ser. No. IB 2019/060457, filed on Dec. 4, 2019.

The first and/or second sets of abrasive particles are typically selected to have a length in a range of from 1 micron to 15000 microns, more typically 10 microns to about 10000 microns, and still more typically from 150 to 2600 microns, although other lengths may also be used.

The first set of abrasive particles are typically selected to have a side length (measured tip to tip as described with respect to FIG. 5 below) in a range of from 0.1 micron to 3500 microns, more typically 50 microns to 3000 microns, and more typically 100 microns to 2600 microns, although other lengths may also be used. In some embodiments discussed herein, the side length of abrasive particles are at least 1275 microns and less than 1525 microns. In other embodiments herein, the side length of abrasive particles are at least 575 microns and less than 750 microns. In still other embodiments herein, the side length of abrasive particles of at least 450 microns and less than 575 microns. In some embodiments, Abrasive particles may have an aspect ratio (length to thickness) of at least 2, 3, 4, 5, 6, 7, or more.

Surface coatings for the abrasive particles may be used to improve the adhesion between abrasive particles and a binder in abrasive articles, or can be used to aid in electrostatic deposition of the abrasive particles. In one embodiment, surface coatings as described in U. S. Pat. No. 5,352,254 (Celikkaya) in an amount of 0.1 to 2 percent surface coating to abrasive particle weight may be used. Such surface coatings are described in U.S. Pat. No. 5,213,591 (Celikkaya et al.); U.S. Pat. No. 5,011,508 (Wald et al.); U.S. Pat. No. 1,910,444 (Nicholson); U.S. Pat. No. 3,041,156 (Rowse et al.); U.S. Pat. No. 5,009,675 (Kunz et al.); U.S. Pat. No. 5,085,671 (Martin et al.); U.S. Pat. No. 4,997,461 (Markhoff-Matheny et al.); and U.S. Pat. No. 5,042,991 (Kunz et al.). Additionally, the surface coating may prevent the abrasive particle from capping. Capping is the term to describe the phenomenon where metal particles from the workpiece being abraded become welded to the tops of the abrasive particles. Surface coatings to perform the above functions are known to those of skill in the art.

Once the first and second abrasive particles have been embedded in the make layer precursor, it is at least partially cured in order to preserve orientation of the mineral during application of the size layer precursor. Typically, this involves B-staging the make layer precursor, but more advanced cures may also be used if desired. B-staging may be accomplished, for example, using heat and/or light and/or use of a curative, depending on the nature of the make layer precursor selected. The make layer precursor may include for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant α,β-unsaturated groups, acrylated urethane, acrylated epoxy, acrylated isocyanurate), epoxy resin (including bis-maleimide and fluorene-modified epoxy resins), isocyanurate resin, and mixtures thereof.

The basis weight of the make layer will also necessarily vary depending on the intended use(s), type(s) of abrasive particles, and nature of the coated abrasive belt being prepared, but generally will be in the range of from 1 or 20 gsm to 200, 300, or even 400 gsm, or more. The size layer precursor may be applied by any known coating method for applying a size layer precursor.

In block 340, a size coat is applied over the embedded particles. The size layer precursor is applied over the at least partially cured make layer precursor and abrasive particles. The size layer can be formed by coating a curable size layer precursor onto a major surface of the backing. The size layer precursor may include for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant α,β-unsaturated groups, acrylated urethane, acrylated epoxy, acrylated isocyanurate), epoxy resin (including bis-maleimide and fluorene-modified epoxy resins), isocyanurate resin, and mixtures thereof. If phenolic resin is used to form the make layer, it is likewise preferably used to form the size layer. The size layer precursor may be applied by any known coating method for applying a size layer to a backing, including roll coating, extrusion die coating, curtain coating, knife coating, gravure coating, spray coating, and the like. If desired, a presize layer precursor or make layer precursor according to the present disclosure may be also used as the size layer precursor.

The basis weight of the size layer will also necessarily vary depending on the intended use(s), type(s) of abrasive particles, and nature of the coated abrasive belt being prepared, but generally will be in the range of from 1 or 50 gsm to 300, 400, or even 800 gsm, or more. The size layer precursor may be applied by any known coating method for applying a size layer precursor (e.g., a size coat) to a backing including, for example, roll coating, extrusion die coating, curtain coating, and spray coating.

Once applied, the size layer precursor, and typically the partially cured make layer precursor, are sufficiently cured to provide a usable coated abrasive article. In general, this curing step involves thermal energy, although other forms of energy such as, for example, radiation curing may also be used. Useful forms of thermal energy include, for example, heat and infrared radiation. Exemplary sources of thermal energy include ovens (e.g., festoon ovens), heated rolls, hot air blowers, infrared lamps, and combinations thereof.

In addition to other components, binder precursors, if present, in the make layer precursor and/or presize layer precursor of coated abrasive belts according to the present disclosure may optionally contain catalysts (e.g., thermally activated catalysts or photocatalysts), free-radical initiators (e.g., thermal initiators or photoinitiators), curing agents to facilitate cure. Such catalysts (e.g., thermally activated catalysts or photocatalysts), free-radical initiators (e.g., thermal initiators or photoinitiators), and/or curing agents may be of any type known for use in coated abrasive belts including, for example, those described herein.

In addition to other components, the make and size layer precursors may further contain optional additives, for example, to modify performance and/or appearance. Exemplary additives include grinding aids, fillers, plasticizers, wetting agents, surfactants, pigments, coupling agents, fibers, lubricants, thixotropic materials, antistatic agents, suspending agents, and/or dyes.

Exemplary grinding aids, which may be organic or inorganic, include waxes, halogenated organic compounds such as chlorinated waxes like tetrachloronaphthalene, pentachloronaphthalene, and polyvinyl chloride; halide salts such as sodium chloride, potassium cryolite, sodium cryolite, ammonium cryolite, potassium tetrafluoroborate, sodium tetrafluoroborate, silicon fluorides, potassium chloride, magnesium chloride; and metals and their alloys such as tin, lead, bismuth, cobalt, antimony, cadmium, iron, and titanium. Examples of other grinding aids include sulfur, organic sulfur compounds, graphite, and metallic sulfides. A combination of different grinding aids can be used.

Exemplary antistatic agents include electrically conductive material such as vanadium pentoxide (e.g., dispersed in a sulfonated polyester), humectants, carbon black and/or graphite in a binder.

Examples of useful fillers for this disclosure include silica such as quartz, glass beads, glass bubbles and glass fibers; silicates such as talc, clays, (montmorillonite) feldspar, mica, calcium carbonate, calcium silicate, calcium metasilicate, sodium aluminosilicate, sodium silicate; metal sulfates such as calcium sulfate, barium sulfate, sodium sulfate, aluminum sodium sulfate, aluminum sulfate; gypsum; vermiculite; wood flour; aluminum trihydrate; carbon black; aluminum oxide; titanium dioxide; cryolite; chiolite; and metal sulfites such as calcium sulfite.

Additionally, in some embodiments, in block 350, a supersize coat is applied over the size coat. The supersize coat may include fillers, grinding aids, lubricants, binders or suitable other materials. If present, the supersize typically includes grinding aids and/or anti-loading materials. The optional supersize layer may serve to prevent or reduce the accumulation of swarf (the material abraded from a workpiece) between abrasive particles, which can dramatically reduce the cutting ability of the coated abrasive belt. Useful supersize layers typically include a grinding aid (e.g., potassium tetrafluoroborate), metal salts of fatty acids (e.g., zinc stearate or calcium stearate), salts of phosphate esters (e.g., potassium behenyl phosphate), phosphate esters, urea-formaldehyde resins, mineral oils, crosslinked silanes, crosslinked silicones, and/or fluorochemicals. Useful supersize materials are further described, for example, in U. S. Pat. No. 5,556,437 (Lee et al.) and U.S Pat No. 5,508,850 (Helmin) Typically, the amount of grinding aid incorporated into coated abrasive products is about 50 to about 700 gsm, more typically about 80 to about 500 gsm. The supersize may contain a binder such as for example, those used to prepare the size or make layer, but it need not have any binder.

Further details concerning the construction of coated abrasive articles comprising an abrasive layer secured to a backing, wherein the abrasivfe layer includes abrasive particles and make, size, and optional supersize layers are well known, and may be found, for example, in U.S. Pat. No. 4,734,104 (Broberg); U.S. Pat. No. 4,737,163 (Larkey); U.S. Pat. No. 5,203,884 (Buchanan et al.); U.S. Pat. No. 5,152,917 (Pieper et al.); U.S. Pat. No. 5,378,251 (Culler et al.); U.S. Pat. No. 5,417,726 (Stout et al.); U.S. Pat. No. 5,436,063 (Follett et al.); U.S. Pat. No. 5,496,386 (Broberg et al.); U.S. Pat. No. 5,609,706 (Benedict et al.); U.S. Pat. No. 5,520,711 (Helmin); U.S. Pat. No. 5,954,844 (Law et al.); U.S. Pat. No. 5,961,674 (Gagliardi et al.); U.S. Pat. No. 4,751,138 (Bange et al.); U.S. Pat. No. 5,766,277 (DeVoe et al.); U.S. Pat. No. 6,077,601 (DeVoe et al.); U.S. Pat. No. 6,228,133 (Thurber et al.); and U.S. Pat. No. 5,975,988 (Christianson).

FIG. 4 illustrates a cutaway view of an exemplary abrasive article in accordance with embodiments herein. Abrasive article 400 may be an abrasive belt, for example. Coated abrasive article 400 has a backing (substrate) 400. Abrasive particles 430 are coupled to backing 410 by a make coat 412. Abrasive particles 430 are illustrated as equilateral triangles, but this is by example only. It is expressly contemplated that abrasive particles 430 may be any suitable shape. Abrasive particles 430 may be covered by a size coat 440.

Coated abrasive articles generally include a backing, abrasive particles, and at least one binder to secure the abrasive particles to the backing. The backing can be any suitable material, including cloth, polymeric film, fiber, nonwoven webs, paper, combinations thereof, and treated versions thereof. Suitable binders include inorganic or organic binders (including thermally curable resins and radiation curable resins). The abrasive particles can be present in one layer or in two layers of the coated abrasive article.

Binder materials may also contain filler materials or grinding aids, typically in the form of a particulate material. Typically, the particulate materials are inorganic materials. Examples of useful fillers for this disclosure include: metal carbonates (e.g., calcium carbonate (e.g., chalk, calcite, marl, travertine, marble and limestone), calcium magnesium carbonate, sodium carbonate, magnesium carbonate), silica (e.g., quartz, glass beads, glass bubbles and glass fibers) silicates (e.g., talc, clays, (montmorillonite) feldspar, mica, calcium silicate, calcium metasilicate, sodium aluminosilicate, sodium silicate) metal sulfates (e.g., calcium sulfate, barium sulfate, sodium sulfate, aluminum sodium sulfate, aluminum sulfate), gypsum, vermiculite, wood flour, aluminum trihydrate, carbon black, metal oxides (e.g., calcium oxide (lime), aluminum oxide, titanium dioxide), and metal sulfites (e.g., calcium sulfite).

In general, the addition of a grinding aid increases the useful life of the abrasive article. A grinding aid is a material that has a significant effect on the chemical and physical processes of abrading, which results in improved performance. Although not wanting to be bound by theory, it is believed that a grinding aid(s) will (a) decrease the friction between the abrasive particles and the workpiece being abraded, (b) prevent the abrasive particles from “capping” (i.e., prevent metal particles from becoming welded to the tops of the abrasive particles), or at least reduce the tendency of abrasive particles to cap, (c) decrease the interface temperature between the abrasive particles and the workpiece, or (d) decreases the grinding forces.

Grinding aids can be particularly useful in coated abrasive and bonded abrasive articles. In coated abrasive articles, grinding aid is typically used in the supersize coat, which is applied over the surface of the abrasive particles. Sometimes, however, the grinding aid is added to the size coat. Typically, the amount of grinding aid incorporated into coated abrasive articles are about 50-300 g/m² (desirably, about 80-160 g/m²). In vitrified bonded abrasive articles grinding aid is typically impregnated into the pores of the article.

The abrasive particles may be uniformly distributed in the abrasive article or concentrated in selected areas or portions of the abrasive article. For example, in a coated abrasive, there may be two layers of abrasive particles. The first layer comprises abrasive particles other than shaped ceramic abrasive particles made according to the present disclosure, and the second (outermost) layer comprises shaped ceramic abrasive particles made according to the present disclosure. Likewise in a bonded abrasive, there may be two distinct sections of the grinding wheel. The outermost section may comprise abrasive particles made according to the present disclosure, whereas the innermost section does not. Alternatively, shaped ceramic abrasive particles made according to the present disclosure may be uniformly distributed throughout the bonded abrasive article.

Further details regarding coated abrasive articles can be found, for example, in U.S. Pat. No. 4,734,104 (Broberg), U.S. Pat. No. 4,737,163 (Larkey), U.S. Pat. No. 5,203,884 (Buchanan et al.), U.S. Pat. No. 5,152,917 (Pieper et al.), U.S. Pat. No. 5,378,251 (Culler et al.), U.S. Pat. No. 5,417,726 (Stout et al.), U.S. Pat. No. 5,436,063 (Follett et al.), U.S. Pat. No. 5,496,386 (Broberg et al.), U.S. Pat. No. 5,609,706 (Benedict et al.), U.S. Pat. No. 5,520,711 (Helmin), U.S. Pat. No. 5,954,844 (Law et al.), U.S. Pat. No. 5,961,674 (Gagliardi et al.), and U.S. Pat. No. 5,975,988 (Christianson). Further details regarding bonded abrasive articles can be found, for example, in U.S. Pat. No. 4,543,107 (Rue), U.S. Pat. No. 4,741,743 (Narayanan et al.), U.S. Pat. No. 4,800,685 (Haynes et al.), U.S. Pat. No. 4,898,597 (Hay et al.), U.S. Pat. No. 4,997,461 (Markhoff-Matheny et al.), U.S. Pat. No. 5,037,453 (Narayanan et al.), U.S. Pat. No. 5,110,332 (Narayanan et al.), and U.S. Pat. No. 5,863,308 (Qi et al.). Further details regarding vitreous bonded abrasives can be found, for example, in U.S. Pat. No. 4,543,107 (Rue), U.S. Pat. No. 4,898,597 (Hay et al.), U.S. Pat. No. 4,997,461 (Markhoff-Matheny et al.), U.S. Pat. No. 5,094,672 (Giles Jr. et al.), U.S. Pat. No. 5,118,326 (Sheldon et al.), U.S. Pat. No. 5,131,926 (Sheldon et al.), U.S. Pat. No. 5,203,886 (Sheldon et al.), U.S. Pat. No. 5,282,875 (Wood et al.), U.S. Pat. No. 5,738,696 (Wu et al.), and U.S. Pat. No. 5,863,308 (Qi). Further details regarding nonwoven abrasive articles can be found, for example, in U.S. Pat. No. 2,958,593 (Hoover et al.).

The present disclosure provides a method of abrading a surface, the method comprising contacting at least one shaped ceramic abrasive particle made according to the present disclosure, with a surface of a workpiece; and moving at least of one the shaped ceramic abrasive particles or the contacted surface to abrade at least a portion of said surface with the abrasive particle. Methods for abrading with shaped ceramic abrasive particles made according to the present disclosure range from snagging (i.e., high pressure high stock removal) to polishing (e.g., polishing medical implants with coated abrasive belts), wherein the latter is typically done with finer grades (e.g., ANSI 220 and finer) of abrasive particles. The shaped ceramic abrasive particles may also be used in precision abrading applications, such as grinding cam shafts with vitrified bonded wheels. The size of the abrasive particles used for a particular abrading application will be apparent to those skilled in the art.

Abrading with shaped ceramic abrasive particles made according to the present disclosure may be done dry or wet. For wet abrading, the liquid may be introduced supplied in the form of a light mist to complete flood. Examples of commonly used liquids include: water, water-soluble oil, organic lubricant, and emulsions. The liquid may serve to reduce the heat associated with abrading and/or act as a lubricant. The liquid may contain minor amounts of additives such as bactericide, antifoaming agents.

Shaped ceramic abrasive particles made according to the present disclosure may be useful, for example, to abrade workpieces such as aluminum metal, carbon steels, mild steels, tool steels, stainless steel, hardened steel, titanium, glass, ceramics, wood, wood-like materials (e.g., plywood and particle board), paint, painted surfaces, organic coated surfaces and the like. The applied force during abrading typically ranges from about 1 to about 100 kilograms.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Unit Abbreviations used in the Examples: gsm=grams per square meter, ° C.=degrees Celsius; cm=centimeter; mm=millimeter; μm=micrometer; fpm=feet per minute; and kV=kilovolts.

Table 2, below, reports material used in the Examples.

TABLE 2

| | |
|---|---|
| PFR | Phenol-formaldehyde resin having a phenol to formaldehyde molar ratio of 1:1.5- |
| | 2.1, and catalyzed with 2.5 percent by weight potassium hydroxide |
| EPR1 | Bisphenol A based water dispersed resin available as Epirez 3522 W60 from |
| | Hexion, Columbus, Ohio |
| AD1 | An antifoam available as antifoam 1430 from Dow Chemical, Midland, Michigan |
| AD2 | A surfactant available as Aerosol OT-NV from Solvay, Albright, West Virginia |
| AD3 | A curing agent available as Imicure EMI 2, 4 from Evonik, Allentown, |
| | Pennsylvania |
| AD4 | Fumed silica available as Cab-O-Sil M5 from Cabot, Billerica, Maryland |
| FIL1 | Calcium silicate available as M400 WOLLASTOCOAT from NYCO, Willsboro, |
| | New York. |
| FIL2 | Trisodium hexafluoroaluminate available as Cryolite RTN-C from Freebee A/S, |
| | Nyborg, Denmark. |
| FIL2 | Potassium tetrafluoroborate available from AWSW Industries, Paramus, New |
| | Jersey |
| LT1 | Latex dispersion available as Sure Tac 1585from Dyna Tech Adhesive Inc., |
| | Grafton, West Virginia |
| PIG1 | Iron oxide available as KROMA SYNTHETIC IRON OXIDE RED RO3097 from |
| | Venator Americas LLC, Woodlands, Texas. |
| PIG2 | A pigment dispersion available as VW3620 AQUIS Carbazole Violet from |
| | Heubach, Fairless Hill, Pennsylvania |
| PIG 3 | Titanium dioxide available as titanium dioxide R-960 Ti-Pure from Dupont, |
| | Wilmington, Delaware |
| PEB | Polyester backing as described in U.S. Pat. No. 6,843,815, page 16, line 26 backing |
| | example 12. |
| MR1 | Make resin 1, prepared by mixing 51.84 parts by weight of PFR, 42.12 parts by |
| | weight of FIL1, and 6.04 parts by weight of tap water |
| SZ1 | Size resin 1, prepared by mixing 42.11 parts by weight of PFR, 22.14 parts by |
| | weight of FIL1, 22.14 parts by weight of FIL2, 1.55 parts by weight of PIG1, and |
| | 12.06 parts by weight of tap water |
| SZ2 | Size resin 2, prepared by mixing 42.57 parts by weight of PFR, 23.97 parts by |
| | weight of FIL1, 23.97 parts by weight of FIL1, 0.45 parts by weight of PIG2, 1.56 |
| | parts by weight of PIG 3 and 6.10 parts by weight of tap water |
| SSZ1 | Supersize resin 1, prepared by mixing 14.6 parts by weight of EPR1, 0.06 parts by |
| | weight of AD1, 0.6 parts by weight of AD2, 0.35 parts by weight of AD3, 65.74 |
| | parts by weight of FIL 3, 1.84 parts by weight of PIG 1, 10. parts by weight LX1, |
| | 0.30 parts by weight AD4 and 5.0 parts by weight of tap water |
| SSZ2 | Supersize resin 2 , prepared by mixing 30.06 parts by weight of EPR1, 0.04 parts |
| | by weight of AD1, 0.76 parts by weight of AD2, 0.35 parts by weight of AD3, |
| | 54.72 parts by weight of FIL 3, 0.58 parts by weight of PIG 2, 0.98 parts by |
| | weight PIG3, 0.30 parts by weight AD4 and 5.0 parts by weight of tap water |
| 984F 36+ | 984F 36+ is available as 984F 36+ Cubitron(TM)II cloth belt from 3M, St. Paul, |
| | Minnesota. |
| Actirox | Actirox 890Y 36 is available as AK 890Y 36 cloth belt from VSM Abrasives |
| 890Y 36 | Corp., O'Fallon, Missouri. |

TABLE 3

| | | | | | Size(SZ) and |
|---|---|---|---|---|---|
| | Make | Mineral | Size | Supersize | Supersize |
| | Wt GSM, | Wt GSM, | Wt GSM, | Wt GSM, | Resin (SSZ) |
| Abrasive | g/m2 | g/m2 | g/m2 | g/m2 | Choice |
| EX2-A-1 | 207 | 402 | 606 | 458 | 1 |
| EX2-A-2 | 207 | 407 | 605 | 459 | 2 |
| EX2-B-1 | 207 | 474 | 606 | 457 | 1 |
| EX2-B-2 | 207 | 466 | 606 | 458 | 2 |
| EX2-C-1 | 209 | 545 | 607 | 459 | 1 |
| EX2-C-2 | 209 | 550 | 608 | 458 | 2 |
| EX3-A-2 | 204 | 423 | 606 | 445 | 2 |
| EX3-B-2 | 204 | 509 | 608 | 463 | 2 |
| EX3-C-2 | 204 | 542 | 607 | 462 | 2 |

### Example 1: Coated Abrasive Sample

### Coated Abrasive Sample Preparation for Example 1 (EX1-A-2)

Coated abrasive samples were prepared by coating 12″ wide backing PEB with MR1 using a roll coater to deliver a weight of 210 gsm (grams per square meter). Abrasive particles 250 were electrostatically coated into the make resin at a mineral weight of 546 gsm. The samples were cured at 90° C. for 90 minutes and at 102° C. for 1 hour. Next, samples were sized using a roll coater with SZ2 to a weight of 609 gsm. The samples were cured at 90° C. for 60 minutes and at 102° C. for 1 hour. Next, samples were supersized using a roll coater with SSZ2 to a weight of 483 gsm. Finally, samples were cured at 90° C. for 30 minutes, 102° C. for 12 hours and 110° C. for 1 hour. The belts were then converted into 7.62 cm×335.28 cm for testing using Grinding Test 1 and 7.62 cm×91.44 cm for testing using Grinding Tests 2, 3, 5, 6.

### Coated Abrasive Sample Preparation for Examples 2 & 3

Coated abrasive samples were prepared by coating 4″ wide backing PEB with MR1 using a knife coating set to deliver a weight of 210 gsm, Abrasive particles 250 electrostatically coated into make resin to a specified weight in gsm, as shown in Table 3. The samples were cured at 90° C. for 90 minutes and at 102° C. for 1 hour. Next samples were sized using a 3″ paint roller with SZ1 or SZ2 to a specific weight in gsm, as shown in Table 3. The samples were cured at 90° C. for 60 minutes and at 102° C. for 1 hour. Next, samples were supersized to a weight in gsm, as shown in Table 3. Finally, samples were cured at 90° C. for 30 minutes, 102° C. for 12 hours and 110° C. for 1 hour. The belts were then converted into 7.62 cm×91.44 cm for testing.

### Performance Tests

### Grinding Test 1

Grinding Test 1 (GT1) was conducted using a Hammond Back Stand Polishing and Buffing Machine model #10-ROH-D-VFD, serial #11368, available from by Hammond Roto Finish, Kalamazoo, MI. A 35.56 cm diameter 90 durometer contact wheel was used with a 1 to 1 serration pattern with 0.95 cm by 0.95 grooves. The test was conducted using a 7.62 cm×335. 28 cm abrasive belt. The belt was run at 1800 rpm. The workpiece was a 304 stainless steel bar having dimensions of 1.9 cm×1.9 cm×60.96 cm, on which the surface to be abraded measured 1.9 cm by 1.9 cm. 10 workpieces were used for each test. The weight in grams of each workpiece was recorded prior to each grinding cycle.

During each grinding cycle, each workpiece was forced into the belt using an elevated table platform equipped with a pneumatic cylinder. The complete test was run at one of three force settings: 5.54 kg (12.2 lb) (Low Pressure or “LP”), 10.08 kg (22.2 lb) (Medium Pressure or “MP”), and 13.63 kg (30 lb) (High Pressure or “HP”), depending on what test pressure was needed. One of the 10 workpieces was plunged into center of belt, removed after 8 seconds, placed in room temperature water to cool for at least 10 seconds, dried with paper towel, and the loss-in-weight in grams of the workpiece for the 8 second plunge was recorded. The remaining 9 workpieces were then ground, cooled, and weighed in the same manner until all 10 workpieces had been abraded. This set of 10 plunges is referred to as a “cycle.”

Additional cycles of 10 plunges were then run in the same manner. At a certain point, 50% of the area of the ground surface of a workpiece became oxidized from excessive heat, which is visually indicated by a blue discoloration. The cycle in which the discoloration was observed was completed so that all 10 workpieces had been plunged the same number of times. At this point, the test was concluded.

The results of Grinding Test 1 are shown in Table 4. The total cut (GT1 Total Cut) in grams was calculated by adding up the loss-in-weight data across all cycles for all 10 workpieces. Depending on the pressure chosen for the test, the results may be referred to as GT1 Total Cut LP, GT1Total Cut MP, or GT1 Total Cut HP. The initial cut (GT1 Initial Cut LP, GT1 Initial Cut MP, or GT1 Initial Cut HP) in grams was calculated by adding up the loss-in-weight data for the first 2 cycles for all 10 workpieces. The cut rate (GT1 Cut Rate LP, GT1 Cut Rate MP, GT1 Cut Rate HP) in grams per cycle was calculated by subtracting the total loss-in-weight data after the first 3 cycles from the total loss-in-weight data after the first 15 cycles, and dividing the result by twelve.

### Grinding Test 2

Grinding Test 2 (GT2) was conducted on 10.16 cm by 91.44 cm belts converted from coated abrasive samples. A 20.3 cm diameter 70 durometer rubber, 1:1 land to groove ratio, serrated contact wheel was used. The belt was run at 2750 rpm. The workpiece was a 304 stainless steel bar having dimensions of 1.9 cm×1.9 cm×60.96 cm, on which the surface to be abraded measured 1.9 cm by 1.9 cm. The workpiece weight was recorded in grams then was forced into the center part of the belt at a normal force that varied from 4.5 to 6.8 kg. Each cycle of the test consisted of 16 seconds of grinding. The workpiece was then cooled by quenching 1.3 cm of the abraded end of the workpiece in 15.5° C. water for 8 seconds followed by a continuous jet of pressurized air for 10 seconds to dry the workpiece. The workpiece was then weighed to determine the amount of material removed in grams which concluded the cycle. The final workpiece weight from the previous cycle was used as the initial workpiece weight for the ensuing cycle. If the final mass of the workpiece after abrasion weighed less than 275 grams, a new 304 stainless steel bar having dimensions of 1.9 cm×1.9 cm×60.96 cm was weighed and used for the ensuing cycle. The test was concluded after 40 cycles. The initial cut (GT2 Initial Cut) in grams was defined as the total amount cut after 2 cycles. The cut rate (GT2 Cut Rate) in grams was defined as the total amount of cut after 10 cycles minus the total amount of cut after 3 cycles, divided by 7. The total cut (GT2 Total Cut) in grams was defined as the total amount cut after 40 cycles.

### Grinding Test 3

Grinding Test 3 (GT3) was conducted on 10.16 cm by 91.44 cm belts converted from coated abrasive samples. A 20.3 cm diameter 70 durometer rubber, 1:1 land to groove ratio, serrated contact wheel was used. The belt was run at 2750 rpm. The workpiece was a 304 stainless steel bar having dimensions of 1.9 cm×1.9 cm×60.96 cm, on which the surface to be abraded measured 1.9 cm by 1.9 cm. The workpiece weight was recorded in grams then was forced into the center part of the belt at a normal force that varied from 6.8 to 11.3 kg. Each cycle of the test consisted of 16 seconds of grinding. The workpiece was then cooled by quenching 1.3 cm of the abraded end of the workpiece in 15.5° C. water for 8 seconds followed by a continuous jet of pressurized air for 10 seconds to dry the workpiece. The workpiece was then weighed to determine the amount of material removed in grams which concluded the cycle. The final workpiece weight from the previous cycle was used as the initial workpiece weight for the ensuing cycle. If the final mass of the workpiece after abrasion weighed less than 275 grams, a new 304 stainless steel bar having dimensions of 1.9 cm×1.9 cm×60.96 cm was weighed and used for the ensuing cycle. The test was concluded after 40 cycles. The initial cut (GT3 Initial Cut) in grams was defined as the total amount cut after 2 cycles. The cut rate (GT3 Cut Rate) in grams was defined as the total amount of cut after 10 cycles minus the total amount of cut after 3 cycles, divided by 7. The total cut (GT3 Total Cut) in grams was defined as the total amount cut after 40 cycles.

### Grinding Test 4

Grinding Test 4 (GT4) was conducted on 10.16 cm by 91.44 cm belts converted from coated abrasive samples. A 20.3 cm diameter 70 durometer rubber, 1:1 land to groove ratio, serrated contact wheel was used. The belt was run at 2750 rpm. The workpiece was a 304 stainless steel bar having dimensions of 1.9 cm×1.9 cm×60.96 cm, on which the surface to be abraded measured 1.9 cm by 1.9 cm. The workpiece weight was recorded in grams then was forced into the center part of the belt. The test was run at one of three force settings: 5.9 kg (13 1b) (Low Pressure or “LP”), 8.62 kg (19 1b) (Medium Pressure or “MP”), and 11.34 kg (25 1b) (High Pressure or “HP”), depending on what test pressure was needed. Each cycle of the test consisted of 6 seconds of grinding. The workpiece was then cooled by quenching 1.3 cm of the abraded end of the workpiece in 15.5° C. water for 8 seconds followed by a continuous jet of pressurized air for 10 seconds to dry the workpiece. The workpiece was then weighed to determine the amount of material removed in grams which concluded the cycle. The final workpiece weight from the previous cycle was used as the initial workpiece weight for the ensuing cycle. If the final mass of the workpiece after abrasion weighed less than 275 grams, a new 304 stainless steel bar having dimensions of 1.9 cm×1.9 cm×60.96 cm was weighed and used for the ensuing cycle. The test was concluded after 120 cycles. The initial cut (GT4 Initial Cut) in grams was defined as the total amount cut after 5 cycles. The cut rate (GT4 Cut Rate) in grams was defined as the total amount of cut after 40 cycles minus the total amount of cut after 8 cycles, divided by thirty-two. The total cut (GT4 Total Cut) in grams was defined as the total amount cut after 120 cycles. Depending on the pressure chosen, the results may be referred to as GT4 Initial Cut LP, GT4 Initial Cut MP, GT4 Initial Cut HP, GT4 Cut Rate LP, GT4 Cut Rate MP, GT4 Cut Rate HP, GT4 Total Cut LP, GT4 Total Cut MP or GT4 Total Cut HP.

### Grinding Test 5

Grinding Test 5 (GT5) was conducted on 10.16 cm by 91.44 cm belts converted from coated abrasive samples. A 20.3 cm diameter 70 durometer rubber, 1:1 land to groove ratio, serrated contact wheel was used. The belt was run at 2750 rpm. The workpiece was a 304 stainless steel bar having dimensions of 1.9 cm×1.9 cm×60.96 cm, on which the surface to be abraded measured 1.9 cm by 1.9 cm. The workpiece weight was recorded in grams then was forced into the center part of the belt at a normal force that varied from 3.2 to 4.5 kg. Each cycle of the test consisted of 16 seconds of grinding. The workpiece was then cooled by quenching 1.3 cm of the abraded end of the workpiece in 15.5° C. water for 8 seconds followed by a continuous jet of pressurized air for 10 seconds to dry the workpiece. The workpiece was then weighed to determine the amount of material removed in grams which concluded the cycle. The final workpiece weight from the previous cycle was used as the initial workpiece weight for the ensuing cycle. If the final mass of the workpiece after abrasion weighed less than 275 grams, a new 304 stainless steel bar having dimensions of 1.9 cm×1.9 cm×60.96 cm was weighed and used for the ensuing cycle. The test was concluded after 30 cycles. The initial cut (GT5 Initial Cut) in grams was defined as the total amount cut after 2 cycles. The cut rate (GT5 Cut Rate) in grams was defined as the total amount of cut after 10 cycles minus the total amount of cut after 3 cycles, divided by 7. The total cut (GT5 Total Cut) in grams was defined as the total amount cut after 30 cycles.

### Grinding Test 6

Grinding Test 6 (GT6) was conducted on 10.16 cm by 91.44 cm belts converted from coated abrasive samples. A 20.3 cm diameter 70 durometer rubber, 1:1 land to groove ratio, serrated contact wheel was used. The belt was run at 2750 rpm. The workpiece was a 304 stainless steel bar having dimensions of 1.9 cm×1.9 cm×60.96 cm, on which the surface to be abraded measured 1.9 cm by 1.9 cm. The workpiece weight was recorded in grams then was forced into the center part of the belt at a normal force of 2.3 kg. Each cycle of the test consisted of 16 seconds of grinding. The workpiece was then cooled by quenching 1.3 cm of the abraded end of the workpiece in 15.5° C. water for 8 seconds followed by a continuous jet of pressurized air for 10 seconds to dry the workpiece. The workpiece was then weighed to determine the amount of material removed in grams which concluded the cycle. The final workpiece weight from the previous cycle was used as the initial workpiece weight for the ensuing cycle. If the final mass of the workpiece after abrasion weighed less than 275 grams, a new 304 stainless steel bar having dimensions of 1.9 cm×1.9 cm×60.96 cm was weighed and used for the ensuing cycle. The test was concluded after 30 cycles. The initial cut (GT6 Initial Cut) in grams was defined as the total amount cut after 2 cycles. The cut rate (GT6 Cut Rate) in grams was defined as the total amount of cut after 10 cycles minus the total amount of cut after 3 cycles, divided by 7. The total cut (GT6 Total Cut) in grams was defined as the total amount cut after 30 cycles.

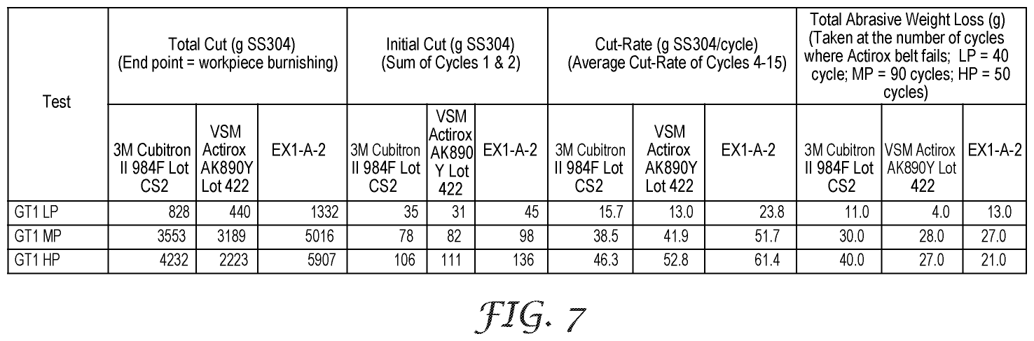

Table 4 is shown in FIG. 7.

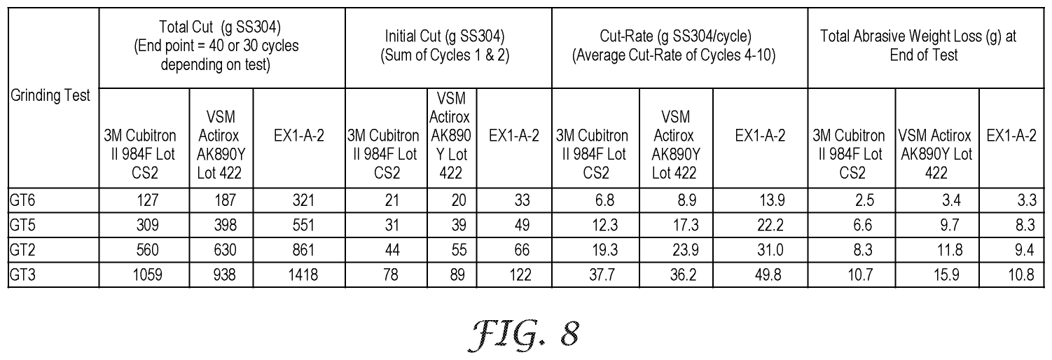

Table 5 is shown in FIG. 8.

TABLE 6

| | | | | Cut-Rate | |
|---|---|---|---|---|---|
| | | Total Cut | Initial Cut | (g SS304/cycle) | |
| | | (g SS304) | (g SS304) | (Average Cut- | Total Abrasive |
| Grinding | | (End point = | (Sum of | Rate of Cycles | Weight Loss (g) |
| Test | Abrasive | 40 cycles) | Cycles 1 & 2) | 4-10) | at End of Test |
| GT3 | EX2-A-1 | 1273 | 102 | 43.7 | 13.6 |
| GT3 | EX2-B-1 | 1352 | 106 | 46.0 | 14.1 |
| GT3 | EX2-C-1 | 1339 | 100 | 44.6 | 13.2 |
| GT3 | EX2-A-2 | 1359 | 94 | 43.5 | 11.2 |
| GT3 | EX2-B-2 | 1434 | 95 | 44.7 | 11.0 |
| GT3 | EX2-C-2 | 1426 | 88 | 42.7 | 9.7 |
| GT3 | 3M Cubitron II | 1041 | 88 | 42.7 | 14.6 |
| | 984F 36+ Lot | | | | |
| | CS2 | | | | |

TABLE 7

| | | | | Cut-Rate | |
|---|---|---|---|---|---|
| | | Total Cut | Initial Cut | (g SS304/cycle) | |
| | | (g SS304) | (g SS304) | (Average Cut- | Total Abrasive |
| | | (End point = | (Sum of | Rate of Cycles | Weight Loss (g) |
| Test | Abrasive | 40 cycles) | Cycles 1 & 2) | 4-10) | at End of Test |
| GT2 | EX3-A-2 | 937 | 59 | 28.5 | 10.1 |
| GT2 | EX3-B-2 | 874 | 49 | 25.4 | 9.9 |
| GT2 | EX3-C-2 | 863 | 46 | 24.1 | 9.9 |
| GT2 | 3M Cubitron II | 573 | 47 | 20.0 | 8.2 |
| | 984F 36+ Lot | | | | |
| | CS2 | | | | |
| GT3 | EX3-A-2 | 1344 | 87 | 40.9 | 12.8 |
| GT3 | EX3-B-2 | 1470 | 89 | 43.0 | 13.3 |
| GT3 | EX3-C-2 | 1404 | 75 | 39.6 | 13.6 |
| GT3 | 3M Cubitron II | 1041 | 88 | 43.0 | 14.6 |
| | 984F 36+ Lot | | | | |
| | CS2 | | | | |

TABLE 8

| Grinding | | Total Cut | Initial Cut | Cut Rate |
|---|---|---|---|---|
| Test | Abrasive | (g SS304) | (g SS304) | (g SS304) |
| GT4 LP | 984F 36+ Lot NR8 | 320 | 35.2 | 3.8 |
| GT4 MP | 984F 36+ Lot NR8 | 670 | 61.2 | 8 |
| GT4 HP | 984F 36+ Lot NR8 | 920 | 76.7 | 10 |

1. An abrasive article comprising:
a backing;
a make coat applied on the backing;
a plurality of shaped abrasive particles embedded in the make coat, wherein each of the plurality of shaped abrasive particles have a side length of at least 50 μm and less than 3000 μm;
wherein a coat weight of the plurality of shaped abrasive particles is greater than 300 particles per square inch; and
wherein the abrasive article, when used to abrade a substrate, exhibits a GT1 Total Cut LP of at least 975 grams, a GT1 Total Cut MP of at least 4250 grams, and a GT1 Total Cut HP of at least 5075 grams in accordance with Grinding Test 1.

2-4. (canceled)

5. The abrasive article of claim 1, wherein each of the plurality of shaped abrasive particles have a side length of at least 575 μm and less than 750 μm.

6. The abrasive article of claim 1, wherein each of the plurality of shaped abrasive particles have a side length of at least 450 μm and less than 575 μm.

7. The abrasive article of claim 1, wherein each of the plurality of shaped abrasive particles have an aspect ratio of at least 3:1 and less than 7:1.

8-10. (canceled)

11. The abrasive article of claim 1, wherein the coat weight is less than 480 particles per square inch.

12. The abrasive article of claim 1, wherein a majority of the shaped abrasive particles are oriented such that a tip is directed away from the backing, and wherein a majority of the shaped abrasive particles are oriented such that a similar surface of each of the majority of shaped abrasive particles face are oriented with respect to a grinding direction.

13-14. (canceled)

15. The abrasive article of claim 1, wherein the abrasive particle is a dish-shaped abrasive particle, such that each of the plurality of shaped abrasive particles are shaped such that each comprises:
a first surface opposite a second surface, separated by a thickness that is substantially constant.

16. (canceled)

17. The abrasive article of claim 1, wherein the abrasive article comprises an abrasive belt.

18. An abrasive article comprising:
a backing;
a make coat applied on the backing;
a plurality of shaped abrasive particles embedded in the make coat, wherein each of the plurality of shaped abrasive particles have a side length of at least 50 μm and less than 3000 μm;
wherein a coat weight of the plurality of shaped abrasive particles is greater than 300 particles per square inch; and
wherein the abrasive article, when used to abrade a substrate, exhibits a GT4 Total Cut LP of at least 390, a GT4 Total Cut MP of at least 800, and a GT4 Total Cut HP of at least 1100 grams in accordance with Grinding Test 4.

19-21. (canceled)

22. The abrasive article of claim 18, wherein each of the plurality of shaped abrasive particles have a side length of at least 575 μm and less than 750 μm.

23. (canceled)

24. The abrasive article of claim 18, wherein each of the plurality of shaped abrasive particles have an aspect ratio of at least 3:1 and less than 7:1.

25-27. (canceled)

28. The abrasive article of claim 18, wherein the coat weight is less than 480 particles per square inch.

29. The abrasive article of claim 18, wherein a majority of the shaped abrasive particles are oriented such that a tip is directed away from the backing and wherein a majority of the shaped abrasive particles are oriented such that a similar surface of each of the majority of shaped abrasive particles face are oriented with respect to a grinding direction.

30-32. (canceled)

33. The abrasive article of claim 18, wherein the plurality of shaped abrasive particles are dish-shaped particles.

34. The abrasive article of claim 18, wherein the abrasive article comprises an abrasive belt.

35. A method of making an abrasive article, the method comprising:
depositing a resin make layer on a backing;
embedding a plurality of abrasive particles in the resin make layer, wherein embedding comprises:
depositing the plurality of abrasive particles;
orienting the plurality of abrasive particles such that a majority of the abrasive particles are oriented such that a tip is directed away from a backing; and
wherein the plurality of abrasive particles are deposited at a coat weight of at least 300 particles per square inch; and
curing the resin make layer.

36. The method of claim 35, wherein the plurality of abrasive particles have an aspect ratio between 3:1 and 7:1.

37. (canceled)

38. The method of claim 35, wherein that a similar surface of each of the majority of the abrasive are oriented with respect to a grinding direction.

39-41. (canceled)

42. The method of claim 1, wherein each of the plurality of abrasive particles has a first curved surface separated from a second curved surface by a thickness.
